(19) United States
(12) Patent Application Publication
(10) Pub. No.: US 2021/0026080 A1
(43) Pub. Date: Jan. 28, 2021

(54) OPTICAL RECEPTACLE AND OPTICAL TRANSCEIVER

(71) Applicant: TOTO LTD., Kitakyushu-Shi (JP)

(72) Inventors: Hirotsugu AGATSUMA, KITAKYUSHU-SHI (JP); Satoshi HAKOZAKI, KITAKYUSHU-SHI (JP); Hiroki SATO, KITAKYUSHU-SHI (JP); Satoshi KANEYUKI, KITAKYUSHU-SHI (JP); Kohei TOMINAGA, KITAKYUSHU-SHI (JP); Arato SUZUKI, KITAKYUSHU-SHI (JP)

(21) Appl. No.: 17/067,081

(22) Filed: Oct. 9, 2020

Related U.S. Application Data
(63) Continuation of application No. 16/356,479, filed on Mar. 18, 2019.
Application No. 16/356,479 is a continuation of application No. PCT/JP2018/013378, filed on Mar. 29, 2018.

(30) Foreign Application Priority Data
Mar. 30, 2017 (JP) 2017-067219
Mar. 14, 2018 (JP) 2018-047131

(51) Int. Cl. G02B 6/38; G02B 6/02; G02B 6/42; G02B 6/30; G02B 6/36

(52) U.S. Cl. CPC G02B 6/3846; G02B 6/02033; G02B 6/421; G02B 6/36; G02B 6/42; G02B 6/30; G02B 6/02; G02B 6/02004

(57) ABSTRACT

An optical receptacle includes a fiber stub, a block, and a first elastic member. The fiber stub includes an optical fiber, and a ferrule provided on one end side of the optical fiber. The block is separated from the ferrule and has one end surface, an other end surface, and a through-hole extending from the one end surface to the other end surface. A portion of the optical fiber protrudes from the ferrule and is inserted into the through-hole. The first elastic member fixes the optical fiber in the through-hole. The portion of the optical fiber includes first to third portions. The second portion is provided between the first portion and the third portion. A core diameter at the first portion is smaller than a core diameter at the third portion. A core diameter at the second portion increases from the first portion toward the third portion.

### CROSS-REFERENCE TO RELATED APPLICATIONS

This is a continuation application of co-pending U.S. application Ser. No. 16/356,479, filed Mar. 18, 2019, which is a continuation of International Application PCT/JP2018/013378, filed on Mar. 29, 2018. This application is also based upon and claims the benefit of priority from the Japanese Patent Application No. 2017-067219, filed on Mar. 30, 2017, and the Japanese Patent Application No. 2018-047131, filed on Mar. 14, 2018; the entire contents of which are incorporated herein by reference.

### FIELD OF THE INVENTION

Embodiments described herein relate generally to an optical receptacle and an optical transceiver for optical communication and relate particularly to an optical receptacle and an optical transceiver favorable for a high-speed communication module.

### BACKGROUND OF THE INVENTION

An optical receptacle is used as a component for optically connecting an optical fiber connector to an optical element such as a light-receiving element, a light-emitting element, or the like in an optical module of an optical communication transceiver.

In recent years, faster optical communication transceivers are necessary as IP traffic increases. Generally, the configurations of transceivers and the like employing receptacle-type optical modules are standardized; the space that is necessary for electrical circuits increases as the modulation rate of an optical signal emitted from a semiconductor laser which is one optical element is becoming faster; and it is desirable to downsize the optical modules.

The mode field diameter (MFD) of a semiconductor laser element is smaller than the core diameter of 10 μm of an optical fiber generally used as the transmission line of an optical signal.

In recent years, to provide a faster communication speed of optical transceivers, a structure of an optical module is being used in which multiple semiconductor lasers are included inside a single module; and the light that is emitted from each of the semiconductor lasers is multiplexed in one waveguide inside an optical waveguide formed in the interior of a plate member and subsequently optically coupled to an optical fiber of an optical receptacle. To downsize these optical modules, it is necessary to downsize the plate member including the optical waveguide described above; and there is a tendency for the core diameter of the optical waveguide to be small.

Also, in an optical module in which a light-receiving element is used instead of a light-emitting element, there is a tendency for the light-receiving diameter of the light-receiving element to be small in order to be used in faster and longer-distance communication applications.

Incidence loss occurs when the diameter of the incident light and the fiber core diameter are different. At the light receiver of the light-receiving element or the like as well, a problem undesirably occurs when light having a large diameter strikes a small light receiver and the light not striking the light receiver is lost. Conventionally, for this problem, methods have been employed in which the size of the diameter is converted using a lens, or the optical fiber is directly connected to the waveguide and/or the optical element on the premise that the loss will occur.

The lens for condensing the light emitted from the semiconductor laser element into the fiber core or for condensing the light emitted from the fiber core into the light-receiving element must have a magnification function in the case where there is a difference between the fiber core diameter and the mode field diameter of the optical element; however, as the difference increases, the focal length of the lens lengthens or the necessary number of lenses increases; and it is problematic in that the optical system is complex and expensive.

To prevent lengthening of the total module length or the higher complexity of the optical system, a method is known in which the magnification due to the lens is suppressed to be small; instead, a lens is formed in the fiber tip which is a portion of the optical element-side-end surface of the optical fiber; or a GI fiber is fused to enlarge the mode field diameter of the incident light to cause a mode field diameter that is optimal for the fiber to be incident on the fiber end surface (e.g., JP-A 2006-154243 (Kokai)).

However, the method of JP-A 2006-154243 (Kokai) uses a GI fiber in which the mode field diameter changes periodically; therefore, to obtain the optimal mode field diameter, the length of the GI fiber must be controlled strictly; and it is problematic in that the control is difficult when manufacturing.

Also, when fusing a fiber such as a GI fiber in which the refractive index is different in stages in the diametrical direction from the core center to the outer perimeter portion, for fusion technology of forming one body by melting the fiber end surfaces, the cores that have different refractive indexes undesirably melt and mix together; therefore, it is difficult to control the refractive index of the fused portion periphery; and it is problematic in that the optical loss is undesirably large.

Also, in JP-A 2006-119633 (Kokai), an optical receptacle is proposed in which the optical element side of the optical fiber is formed in a tapered configuration; and the mode field diameter on the optical element side is set to be smaller than the mode field diameter on the PC (Physical Contact) side. The connection loss can be suppressed thereby. However, in the configuration of JP-A 2006-119633 (Kokai), the tapered configuration is positioned at the end portion on the optical element side. Mirror-surface (polishing) finishing of the two end portions of the optical fiber is necessary not to harm the light incidence and emission. Therefore, according to the condition of the mirror finishing, the diameter undesirably changes; and it is problematic in that it is difficult to stably control the mode field diameter. In other words, in the configuration of JP-A 2006-119633 (Kokai) as well, a high-precision dimensional tolerance is necessary for the axis-direction length of the optical fiber.

### SUMMARY OF THE INVENTION

According to an embodiment of the invention, an optical receptacle is provided and includes a fiber stub, a block, and a first elastic member; the fiber stub includes an optical fiber, and a ferrule provided on one end side of the optical fiber; the optical fiber includes cladding, and a core for transmitting light; the block is separated from the ferrule and has one end surface, an other end surface on the other end surface on a side opposite to the one end surface, and a through-hole extending from the one end surface to the other end surface; a portion of the optical fiber protrudes from the ferrule and is inserted into the through-hole from the one end surface side; the first elastic member fixes the optical fiber in the through-hole; the portion of the optical fiber protruding from the ferrule includes a first portion, a second portion, and a third portion; the first portion is provided on the other end surface side of the third portion; the second portion is provided between the first portion and the third portion; a core diameter at the first portion is smaller than a core diameter at the third portion; a core diameter at the second portion increases from the first portion toward the third portion; and the first elastic member is provided between the optical fiber and an inner wall of the through-hole.

A first invention is an optical receptacle including a fiber stub, a block, and a first elastic member; the fiber stub includes an optical fiber, and a ferrule provided on one end side of the optical fiber; the optical fiber includes cladding, and a core for transmitting light; the block is separated from the ferrule and has one end surface, an other end surface on the other end surface on a side opposite to the one end surface, and a through-hole extending from the one end surface to the other end surface; a portion of the optical fiber protrudes from the ferrule and is inserted into the through-hole from the one end surface side; the first elastic member fixes the optical fiber in the through-hole; the portion of the optical fiber protruding from the ferrule includes a first portion, a second portion, and a third portion; the first portion is provided on the other end surface side of the third portion; the second portion is provided between the first portion and the third portion; a core diameter at the first portion is smaller than a core diameter at the third portion; a core diameter at the second portion increases from the first portion toward the third portion; and the first elastic member is provided between the optical fiber and an inner wall of the through-hole.

According to the optical receptacle, because the core diameter at the first portion is smaller than the core diameter at the third portion, the loss at the optical connection surface can be suppressed; and the length of the optical module can be shortened.

By forming the second portion, an abrupt change of the core shape can be suppressed when transitioning from the first portion to the third portion; therefore, the optical loss at the second portion can be suppressed.

Because the loss of the light at the first portion and the third portion is small, the second portion may be positioned anywhere inside the through-hole of the block when providing the second portion inside the through-hole. Thereby, precise length control of the optical fiber is unnecessary; and the optical receptacle can be manufactured economically.

Also, by causing the MFD of the optical element such as an optical integrated circuit or the like and the MFD of the block interior to approach each other, a connection method (a butt-joint) is possible in which the block is directly pressed onto the optical element while suppressing the coupling loss due to the MFD difference; and the optical devices between the optical element and the block can be reduced. Thereby, a cost reduction and a decrease of the loss due to a device alignment error are possible. Also, by fixing the optical fiber in the through-hole, the number of component parts of the block can be low (e.g., 1); and the assembly can be performed by inserting the optical fiber into the block; therefore, the number of manufacturing processes can be reduced.

Further, the configurations of the first portion and the third portion do not change with respect to the axis direction; and the loss of the light is small; therefore, the second portion can be located without problems anywhere inside the through-hole of the block when providing the second portion inside the through-hole. Thereby, precise length control of the optical fiber on the fiber block is unnecessary; and the receptacle can be manufactured economically.

A second invention is an optical receptacle including a fiber stub, a block, and a first elastic member; the fiber stub includes an optical fiber, and a ferrule provided on one end side of the optical fiber; the optical fiber includes cladding, and a core for transmitting light; the block is separated from the ferrule and has one end surface, an other end surface on a side opposite to the one end surface, and a groove extending from the one end surface to the other end surface and having a V-shaped configuration; a portion of the optical fiber protrudes from the ferrule and is disposed along the groove from the one end surface side; the first elastic member fixes the optical fiber in the groove; the portion of the optical fiber protruding from the ferrule includes a first portion, a second portion, and a third portion; the first portion is provided on the other end surface side of the third portion; the second portion is provided between the first portion and the third portion; a core diameter at the first portion is smaller than a core diameter at the third portion; a core diameter at the second portion increases from the first portion toward the third portion; and the first elastic member is disposed between the optical fiber and the groove.

According to the optical receptacle, the length of the optical module can be small because the core diameter at the first portion is smaller than the core diameter at the third portion.

By forming the second portion, an abrupt change of the core shape can be suppressed when transitioning from the first portion to the third portion; therefore, the optical loss at the second portion can be suppressed.

The configurations of the first portion and the third portion do not change with respect to the axis direction; and the loss of the light is small; therefore, the second portion can be located without problems anywhere on the groove of the block when providing the second portion on the groove. Thereby, precise length control of the optical fiber is unnecessary; and the receptacle can be manufactured economically.

In the case where a bonding agent is used as the first elastic member, a sufficient amount of the bonding agent can be provided between the groove and the optical fiber and on the upper portion of the optical fiber disposed on the groove; therefore, the bonding strength can be increased.

A third invention is the optical receptacle of the second invention, wherein the block includes a first member where the groove is provided, and a second member opposing the first member; the optical fiber is provided between the second member and the groove; and the first elastic member is provided between the optical fiber and the groove and between the optical fiber and the second member.

According to the optical receptacle, the optical fiber can be pressed into the groove by the second member. Thereby, the optical fiber can conform to the groove with high precision.

A fourth invention is the optical receptacle of the first invention, wherein an entirety of the first portion and an entirety of the second portion are positioned between the one end surface and the other end surface in a direction along a central axis of the optical fiber; and the third portion includes a portion protruding from the one end surface.

According to the optical receptacle, the entire regions of the first portion and the second portion conform to the block; and the second portion can be protected from stress from the outside by being fixed by the first elastic member.

A fifth invention is the optical receptacle of the first invention, wherein at least a portion of the first portion is positioned between the one end surface and the other end surface in a direction along a central axis of the optical fiber; and the second portion and the third portion protrude from the one end surface.

According to the optical receptacle, even if the diameter of the cladding at the second portion changes when fusing the optical fiber, only the first portion conforms to the through-hole or the V-shaped groove of the block. For example, the diameter of the first portion is the same over the entire region of the first portion. Therefore, the optical fiber can be fixed to the block without affecting the positional relationship between the block and the core.

A sixth invention is the optical receptacle of the first invention, wherein a refractive index of the core at the first portion, a refractive index of the core at the second portion, and a refractive index of the core at the third portion are equal to each other; a refractive index of the cladding at the first portion is smaller than a refractive index of the cladding at the third portion; and a refractive index of the cladding at the second portion increases from the first portion side toward the third portion side.

According to the optical receptacle, by using a fiber having a large refractive index difference, the light can be confined without scattering even for a small core diameter; and the loss when the light is incident on the fiber can be suppressed. Also, by forming the second portion, the optical loss at the second portion can be suppressed because an abrupt change of the refractive index difference can be suppressed when transitioning from the first portion to the third portion. Also, the raw material of the core can be used commonly; and the loss due to the reflections at the connection portions can be suppressed because a refractive index difference between the cores does not exist at the connection portion between the first portion and the second portion and the connection portion between the second portion and the third portion.

A seventh invention is the optical receptacle of the first invention, wherein a refractive index of the cladding at the first portion, a refractive index of the cladding at the second portion, and a refractive index of the cladding at the third portion are equal to each other; a refractive index of the core at the first portion is larger than a refractive index of the core at the third portion; and a refractive index of the core at the second portion decreases from the first portion side toward the third portion side.

According to the optical receptacle, the cladding can have uniform properties because the cladding can be formed of the same raw material. Thereby, because the melting point also is uniform, the forming of the cladding outer diameter when fusing can be performed easily.

An eighth invention is the optical receptacle of the first invention, wherein an end surface of the optical fiber on the block side is tilted from a plane perpendicular to a central axis of the optical fiber.

According to the optical receptacle, the end surface of the optical fiber is tilted from the plane perpendicular to the central axis of the optical fiber; therefore, the light that is emitted from the optical element connected to the optical receptacle is incident on the optical fiber, is reflected by the end surface of the optical fiber, and is prevented from returning to the optical element; and the optical element can be operated stably.

A ninth invention is the optical receptacle of the first invention, wherein a transparent member is disposed at the end surface of the optical fiber on the other end surface side of the block.

According to the optical receptacle, by mounting an isolator as the transparent member, the reflection of the light incident on the first portion from the optical element or the light emitted from the first portion toward the optical element can be suppressed.

A tenth invention is the optical receptacle of the first invention that further includes a cover portion and a second elastic member; the cover portion covers at least a portion of a part of the optical fiber protruding from the one end surface of the block; and the second elastic member is provided between the cover portion and the block.

According to the optical receptacle, breakage of the optical fiber can be suppressed by providing the second elastic member at the portion of the optical fiber protruding from the block. Also, breakage of the cover portion can be suppressed by providing the second elastic member between the block and the cover portion covering the optical fiber.

An eleventh invention is the optical receptacle of the tenth invention that further includes a third elastic member provided between the cover portion and the block; and the third elastic member is positioned between the block and the second elastic member.

According to the optical receptacle, breakage of the optical fiber can be suppressed by providing the third elastic member at the portion of the optical fiber protruding from the block. Also, breakage of the cover portion can be suppressed by providing the third elastic member between the block and the cover portion covering the optical fiber.

A twelfth invention is an optical transceiver that includes an optical receptacle; the optical receptacle includes a fiber stub, a block, and a first elastic member; the fiber stub includes an optical fiber, and a ferrule provided on one end side of the optical fiber; the optical fiber includes cladding, and a core for transmitting light; the block is separated from the ferrule and has one end surface, an other end surface on the other end surface on a side opposite to the one end surface, and a through-hole extending from the one end surface to the other end surface; a portion of the optical fiber protruding from the ferrule is inserted into the through-hole from the one end surface side; the first elastic member fixes the optical fiber in the through-hole; the portion of the optical fiber protruding from the ferrule includes a first portion, a second portion, and a third portion; the first portion is provided on the other end surface side of the third portion; the second portion is provided between the first portion and the third portion; a core diameter at the first portion is smaller than a core diameter at the third portion; a core diameter at the second portion increases from the first portion toward the third portion; and the first elastic member is provided between the optical fiber and an inner wall of the through-hole.

According to the optical transceiver, by reducing the core of the optical fiber on the optical element-side-end surface and by fusing a fiber having a larger refractive index difference between the core and the cladding than that of a fiber generally used in a transmission line, the loss at the optical connection surface can be suppressed; and by forming a portion where the refractive index and the core diameter transition gradually at the fused portion between the fiber generally used in a transmission line and the fiber having the large refractive index difference between the core and the cladding, the conversion efficiency of the mode field can be suppressed while contributing to the shortening of the optical total module length; as a result, the decrease of the coupling efficiency from the optical element to the plug ferrule can be suppressed.

### BRIEF DESCRIPTION OF THE DRAWINGS

FIG. 1 is a schematic cross-sectional view illustrating an optical receptacle according to a first embodiment;

FIG. 2 is a schematic cross-sectional view illustrating a portion of the optical receptacle according to the first embodiment;

FIG. 3 is a schematic cross-sectional view illustrating a portion of the optical receptacle according to the first embodiment;

FIG. 4 is a schematic cross-sectional view illustrating a portion of the optical receptacle according to the first embodiment;

FIG. 5A and FIG. 5B are schematic views illustrating the propagation of a beam in the optical fiber;

FIG. 6 is a schematic cross-sectional view illustrating a portion of the optical receptacle according to the first embodiment;

FIG. 7 is a schematic cross-sectional view illustrating a portion of the optical receptacle according to the first embodiment;

FIG. 8 is a schematic cross-sectional view illustrating a portion of the optical receptacle according to the first embodiment;

FIG. 9 is a schematic cross-sectional view illustrating a portion of the optical receptacle according to the first embodiment;

FIG. 10 is a schematic cross-sectional view illustrating a portion of the optical receptacle according to the first embodiment;

FIG. 11 is a schematic view illustrating an example of analysis conditions and analysis results used in the investigation;

FIG. 12 is a schematic view illustrating an example of analysis conditions and analysis results used in the investigation;

FIG. 13A and FIG. 13B are schematic views illustrating an example of analysis conditions and analysis results used in the investigation;

FIG. 14A to FIG. 14C are schematic views illustrating an example of an optical receptacle and analysis results of the optical receptacle for a reference example used in an investigation relating to the length of the first portion;

FIG. 15A to FIG. 15C are schematic cross-sectional views illustrating portions of the optical receptacle according to the first embodiment;

FIG. 16 is a schematic perspective view illustrating a portion of the optical receptacle according to the first embodiment;

FIG. 17A and FIG. 17B are schematic views illustrating the portion of the optical receptacle according to the first embodiment;

FIG. 18 is a schematic cross-sectional view illustrating a portion of the optical receptacle according to the first embodiment;

FIG. 19 is a schematic perspective view illustrating the portion of the optical receptacle according to the first embodiment;

FIG. 20 is a schematic cross-sectional view illustrating the portion of the optical receptacle according to the first embodiment;

FIG. 21 is a schematic cross-sectional view illustrating the portion of the optical receptacle according to the first embodiment;

FIG. 22A to FIG. 22C are schematic cross-sectional views illustrating portions of the optical receptacle according to the first embodiment;

FIG. 23 is a schematic perspective view illustrating a portion of the optical receptacle according to the first embodiment;

FIG. 24 is a schematic cross-sectional view illustrating a portion of the optical receptacle according to the first embodiment;

FIG. 25 is a schematic perspective view illustrating a portion of an optical receptacle according to a second embodiment;

FIG. 26 is a schematic cross-sectional view illustrating the portion of the optical receptacle according to the second embodiment; and

FIG. 27A and FIG. 27B are schematic views illustrating an optical transceiver according to a third embodiment.

### DETAILED DESCRIPTION

Embodiments of the invention will now be described with reference to the drawings. Similar components in the drawings are marked with the same reference numerals; and a detailed description is omitted as appropriate.

### First Embodiment

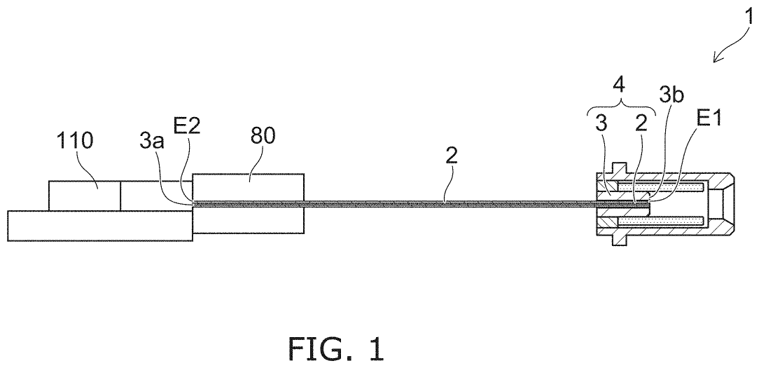

FIG. 1 is a schematic cross-sectional view illustrating an optical receptacle according to a first embodiment.

As shown in FIG. 1, the optical receptacle 1 according to the embodiment includes a fiber stub 4; and the fiber stub 4 includes an optical fiber 2 for transmitting light, and a ferrule 3 provided on one end E1 side of the optical fiber 2. The optical receptacle 1 includes a block (a fixing member) 80 provided on another end E2 side of the optical fiber 2 and separated from the ferrule 3.

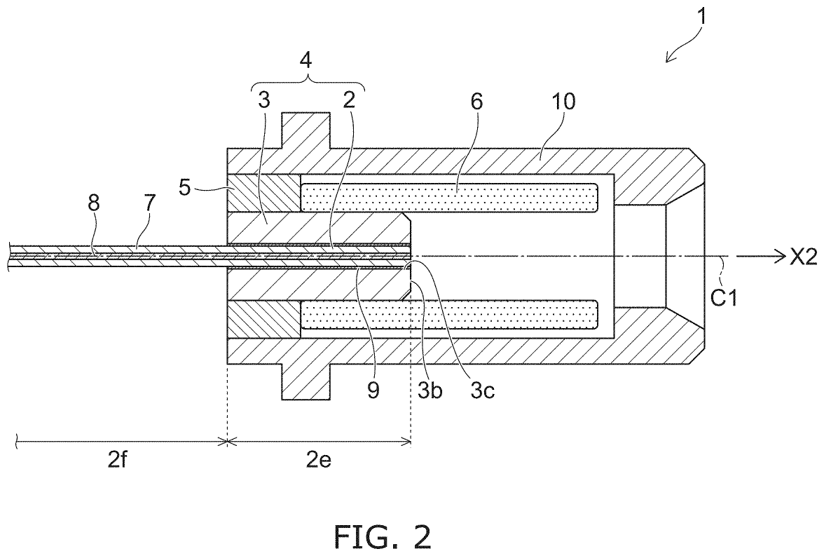

FIG. 2 is a schematic cross-sectional view illustrating a portion of the optical receptacle according to the first embodiment. The periphery of the ferrule 3 illustrated in FIG. 1 is enlarged in FIG. 2.

As illustrated in FIG. 2, the ferrule 3 has a through-hole 3c holding the optical fiber 2. The fiber stub 4 includes an elastic member 9 fixedly bonding the optical fiber 2 in the through-hole 3c.

In the fiber stub 4, the optical fiber 2 is fixed in the through-hole 3c of the ferrule 3 using the elastic member (the bonding agent) 9. The elastic member 9 is, for example, a member having an elastic modulus lower than that of zirconia or a glass fiber. For example, the elastic modulus of the elastic member 9 is lower than the elastic modulus of the optical fiber 2 and the elastic modulus of the ferrule 3. The elastic member 9 performs the roles of the fixation between the optical fiber 2 and the zirconia ferrule 3, the absorption of stress so that the external stress acting on the zirconia ferrule 3 is not transmitted to the glass optical fiber 2, etc. An epoxy resin, an acrylic resin, a silicone resin, etc., are examples of the elastic member 9. The epoxy adhesive, the acrylic bonding agent, the silicone-based bonding agent, etc., can be obtained by curing. Although a resin bonding agent such as epoxy, silicone, or the like is an example of a material suited to the bonding agent used as the elastic member 9, a high temperature-curing epoxy bonding agent is used in the example. The elastic member 9 is filled without leaving gaps in the space existing between the optical fiber 2 and the inner wall of the ferrule 3 inside the through-hole 3c of the ferrule 3.

The optical receptacle 1 further includes a holder 5 holding the fiber stub 4, and a sleeve 6 that holds the tip of the fiber stub 4 at one end and can hold a plug ferrule inserted into the optical receptacle 1 at the other end. The plug ferrule that is inserted into the optical receptacle 1 is not illustrated. The optical receptacle 1 further includes, for example, a housing portion 10. The housing portion 10 engages the outer surface of the holder 5 and covers the ferrule 3 and the sleeve 6. The housing portion 10 covers the ferrule 3 and the sleeve 6 around the axes and protects the ferrule 3 and the sleeve 6 from external force, etc.

Although a ceramic, glass, etc., are examples of materials suited to the ferrule 3, a zirconia ceramic is used; the optical fiber 2 is fixedly bonded at the center of the zirconia ceramic; and one end (an end surface 3b) that is optically connected to the plug ferrule is formed into a convex spherical surface by polishing. Also, it is common for the fiber stub 4 to be fixed by press-fitting into the holder 5 in the assembly of the optical receptacle 1.

Although a resin, a metal, a ceramic, etc., are examples of materials suited to the sleeve 6, a split sleeve that is made of a zirconia ceramic and has a slit in the total length direction is used in the example. The sleeve 6 holds the tip of the fiber stub 4 polished into the convex spherical surface at one end, and holds the plug ferrule inserted into the optical receptacle at the other end.

The optical fiber 2 includes a core 8 extending along the central axis of the optical fiber 2, and cladding 7 surrounding the periphery of the core 8. For example, the refractive index of the core is higher than the refractive index of the cladding. For example, quartz glass is an example of the material of the optical fiber (the core 8 and the cladding 7). An impurity may be added to the quartz glass to control the refractive index.

The optical fiber 2 has a portion 2e fixed to the ferrule 3, and a portion 2f protruding from the ferrule 3. The portion 2e is disposed inside the through-hole 3c of the ferrule 3; and the portion 2f is disposed outside the through-hole 3c.

As illustrated in FIG. 1, the fiber stub 4 has the one end surface (the end surface 3b) optically connected to the plug ferrule, and another end surface (an end surface 3a optically connected to the optical element) on the side opposite to the one end surface. The core 8 is exposed from the cladding 7 at the end surface 3a and the end surface 3b.

For example, an optical element 110 such as a semiconductor laser element, an optical integrated circuit, or the like is disposed on the end surface 3a side. The light that is emitted from the optical element 110 such as the semiconductor laser element, the optical integrated circuit, or the like is incident on the optical receptacle 1 from the end surface 3a side and propagates through the core 8. Or, the light that is incident on the core 8 from the end surface 3b propagates through the core 8 and is emitted toward the optical element 110 from the end surface 3a side.

An optical element such as an isolator or the like may be provided between the end surface 3a and the optical element such as the semiconductor laser element, etc. For example, the isolator includes a polarizer and/or an element (a Faraday element or the like) that rotates the polarization angle and transmits the light in only one direction. Thereby, for example, damage of the laser element, noise, etc., due to the returning light reflected by the end surface 3a can be suppressed.

The fiber stub 4 may be polished so that the end surface 3b is tilted with respect to a plane orthogonal to a central axis C1 (a direction X2). In other words, the convex spherical end surface 3b may be a convex spherical surface obliquely tilted with respect to the plane orthogonal to the central axis C1. Thereby, the optical receptacle 1 is connected optically to an APC (Angled Physical Contact) connector at the end surface 3b; and the reflections and/or the connection loss at the connection point can be suppressed. The direction X2 is the direction in which the portion 2e of the optical fiber fixed to the ferrule 3 extends.

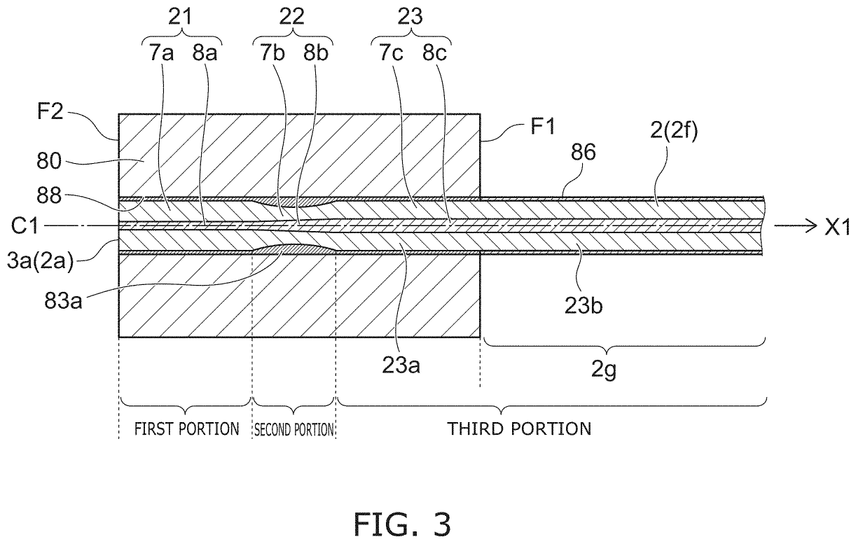

FIG. 3 is a schematic cross-sectional view illustrating a portion of the optical receptacle according to the first embodiment. The periphery of the block 80 illustrated in FIG. 1 is enlarged in FIG. 3.

The block 80 has one end surface (a first surface F1), another end surface (a second surface F2) on the side opposite to the one end surface, and a through-hole 88. The first surface F1 is the end surface on the ferrule 3 side; and the second surface F2 is the end surface on the optical element side. The through-hole 88 extends from the first surface F1 to the second surface F2 and pierces the block 80.

The portion 2f of the optical fiber 2 protruding from the ferrule 3 is inserted into the through-hole 88 from the first surface F1 side. In other words, the portion of the optical fiber 2 protruding from the block 80 at the first surface F1 extends toward the ferrule 3. The block 80 is provided at the end portion of the optical fiber 2 on the optical element side and fixes the optical fiber 2. The block 80 can have a rectangular parallelepiped configuration used to physically fix the position of an end surface 2a of the optical fiber 2. However, when considering the handling property and the protection of a cover 86 of the optical fiber 2, the configuration is not limited to a rectangular parallelepiped and may be any configuration such as a circular column, a polygon, a polygonal pyramid, a circular cone, etc. For example, the block 80 includes a through-hole or a V-shaped groove as the section fixing the optical fiber 2. For example, the material of the block 80 is selectable as appropriate from a resin considering cost and productivity, a ceramic such as zirconia, alumina, etc., having a lower thermal expansion coefficient than that of a resin, a glass fixable using an ultraviolet-curing adhesive, etc.

The optical receptacle 1 also includes an elastic member (a first elastic member) 83a fixedly bonding the optical fiber 2 in the through-hole 88. The elastic member 83a is filled between the optical fiber 2 and the inner wall of the through-hole 88. The end portion of the optical fiber 2 on the optical element side is fixed to the block 80 thereby. The elastic member 83a includes, for example, an epoxy resin, an acrylic resin, a silicone resin, etc. The elastic member 83a may include, for example, substantially the same material as the material described in reference to the elastic member 9.

A cover (the cover portion 86) is provided on the optical fiber 2. The cover portion 86 covers at least a portion of a portion 2g of the optical fiber 2 protruding from the first surface F1 toward the ferrule 3 side. The first surface F1 is positioned between the portion 2g and the second surface F2 in a direction X1 along the central axis C1 of the optical fiber 2.

For example, the cover portion 86 covers the portion of the optical fiber 2 between the block 80 and the ferrule 3. In other words, the cover portion 86 covers the portion of the optical fiber 2 not covered with the ferrule 3 and the block 80. Thereby, the cover portion 86 protects the portion of the optical fiber 2 exposed from the ferrule 3 and the block 80. For example, the cover portion 86 contacts the surface of the optical fiber 2. The cover portion 86 includes, for example, a resin material such as a UV-curing resin, etc.

The portion 2f of the optical fiber 2 protruding from the ferrule 3 includes a first portion 21, a second portion 22, and a third portion 23. The optical fiber 2 is one fiber formed by fusing a fiber used to form the first portion 21 and a fiber used to form the third portion 23. That is, the first portion 21, the second portion 22, and the third portion 23 are one body.

The first portion 21 includes cladding (a first cladding portion 7a) and a core (a first core portion 8a); the second portion 22 includes cladding (a second cladding portion 7b) and a core (a second core portion 8b); and the third portion 23 includes cladding (a third cladding portion 7c) and a core (a third core portion 8c). The first portion 21 is provided on the end surface 3a side when viewed from the third portion 23, that is, on the second surface F2 side of the block 80 when viewed from the third portion 23. The third portion 23 is provided on the end surface 3b side when viewed from the first portion 21, that is, on the first surface F1 side of the block 80 when viewed from the first portion 21. The second portion 22 is provided between the first portion 21 and the third portion 23. The first cladding portion 7a, the second cladding portion 7b, and the third cladding portion 7c each are included in the cladding 7. The first core portion 8a, the second core portion 8b, and the third core portion 8c each are included in the core 8.

In the example, the first portion 21 and the second portion 22 extend along the block 80 and are provided inside the through-hole 88 over their entire regions. In other words, the entire first portion 21 and the entire second portion 22 are positioned between the first surface F1 and the second surface F2 in the direction X1 along the central axis C1 of the optical fiber 2. In other words, the positions of the first portion 21 and the second portion 22 in the direction X1 each are between the position of the first surface F1 in the direction X1 and the position of the second surface F2 in the direction X1.

The direction X1 is the extension direction of the portion of the optical fiber 2 fixed to the block 80, i.e., the portion disposed inside the through-hole 88. For example, as shown in FIG. 1, the direction X1 is parallel to the direction X2 in the case where the optical fiber 2 is disposed in a straight line configuration. However, in the embodiment, the optical fiber 2 may not always have a straight line configuration.

The third portion 23 includes a portion 23a provided inside the through-hole 88, and a portion 23b protruding from the first surface F1 toward the ferrule 3 side. For example, the third portion 23 continues to the end surface 3b connected optically to the plug ferrule. That is, the core diameter, the cladding diameter, the refractive index of the core, the refractive index of the cladding, etc., at the portion 2e of the optical fiber 2 fixed to the ferrule 3 are respectively substantially the same as the core diameter, the cladding diameter, the core refractive index, the cladding refractive index, etc., at the third portion 23.

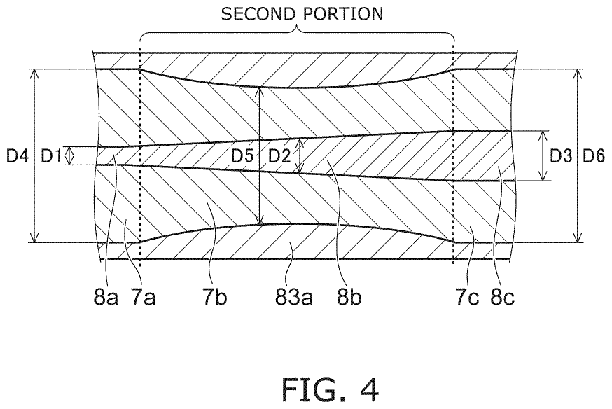

FIG. 4 is a schematic cross-sectional view illustrating a portion of the optical receptacle according to the first embodiment. The periphery of the second portion 22 of the optical fiber 2 is enlarged in FIG. 4.

A core diameter D1 of the first portion 21 is smaller than a core diameter D3 of the third portion 23; and a core diameter D2 of the second portion 22 gradually increases from the first portion 21 toward the third portion 23. A fiber outer diameter D4 at the first portion 21 is, for example, equal to a fiber outer diameter D6 at the third portion 23. A fiber outer diameter D5 at the second portion 22 is smaller than the fiber outer diameter D4 at the first portion 21 and smaller than the fiber outer diameter D6 at the third portion 23. The core diameter is the length of the core, i.e., the diameter of the core, along a direction orthogonal to the central axis C1 (the direction X1). The fiber outer diameter is the length of the fiber (the length of the cladding), i.e., the diameter of the fiber, along the direction orthogonal to the central axis C1 (the direction X1).

For example, the core diameter D1 of the first portion 21 is not less than 0.5 μm and not more than 8 μm. For example, the core diameter D3 of the third portion 23 is not less than 8 μm and not more than 20 μm.

Examples of techniques for forming the second portion 22 include a method in which heat that is not less than the melting point of quartz is applied from the outer perimeter of the fused portion when fusing the first portion 21 and the third portion 23 and the core diameter is increased by the additives of the core diffusing toward the cladding side, a method in which the optical fiber fused portion is pulled while applying heat, etc. It is necessary to design the length of the second portion 22 in the central-axis direction of the optical fiber by considering the length having the lowest loss and the limit of the length that can be pulled while applying heat. It is desirable for the length to be not less than 10 micrometers (μm) and not more than 1000 μm.

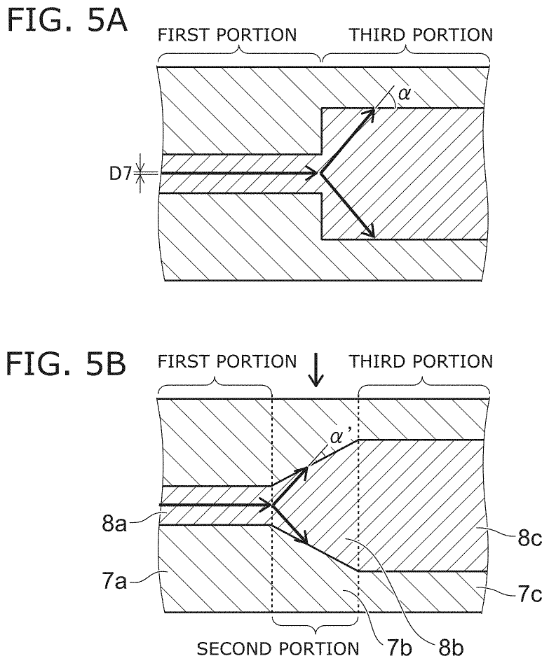

FIG. 5A and FIG. 5B are schematic views illustrating the propagation of a beam in the optical fiber.

For example, as illustrated in FIG. 4, the core diameter D2 of the second portion 22 enlarges linearly when transitioning from the first portion 21 to the third portion 23. By providing such a configuration, even if the laser entering the second portion 22 spreads at a spread angle α, the laser is incident on the wall at a small angle α′ as shown in FIG. 5A and FIG. 5B; and the light is prevented from escaping to the cladding side. However, the rate of pulling the fiber and the electric discharge amount, the electric discharge timing, and the electric discharge position for applying the heat to the fiber must be controlled strictly to make this configuration; and the degree of difficulty of the shape formation is relatively high.

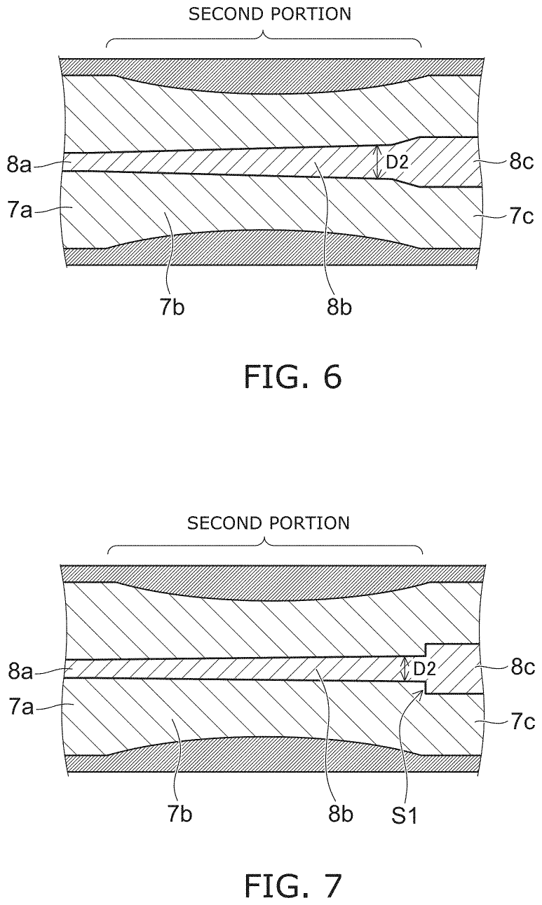

FIG. 6 is a schematic cross-sectional view illustrating a portion of the optical receptacle according to the first embodiment. The periphery of the second portion 22 of the optical fiber 2 is enlarged in FIG. 6.

For example, as illustrated in FIG. 6, the core diameter D2 of the second portion 22 enlarges nonlinearly when transitioning from the first portion 21 to the third portion 23. By providing such a configuration, although there is a possibility that the loss at the conversion portion (the second portion 22) may be larger than when the core enlarges linearly, the tolerable values of the control items recited above are greater; therefore, even for manufacturing equipment in which the electric discharge amount and/or the electric discharge timing cannot be controlled, an advantage is provided in that this configuration can be made using a relatively simple control.

FIG. 7 is a schematic cross-sectional view illustrating a portion of the optical receptacle according to the first embodiment. The periphery of the second portion 22 of the optical fiber 2 is enlarged in FIG. 7.

For example, as illustrated in FIG. 7, the core diameter D2 of the second portion 22 enlarges nonlinearly when transitioning from the first portion 21 to the third portion 23; and a portion of the boundary between the cladding 7 and the core 8 includes a portion S1 (in the specification, this is called a level difference) substantially perpendicular to the fiber central axis C1. By providing such a configuration, an advantage is provided in that this configuration can be made even in the case where it is difficult for the heat to be transferred over the entire region of the second portion 22 when fusing.

The difference between the refractive index of the core and the refractive index of the cladding at the first portion 21 is larger than the difference between the refractive index of the core and the refractive index of the cladding at the second portion 22. The difference between the refractive index of the core and the refractive index of the cladding at the first portion 21 is larger than the difference between the refractive index of the core and the refractive index of the cladding at the third portion 23. The difference between the refractive index of the core and the refractive index of the cladding at the second portion 22 is larger than the difference between the refractive index of the core and the refractive index of the cladding at the third portion 23. For the second portion 22, the refractive index difference is large on the first portion 21 side and gradually decreases toward the third portion 23 side because the second portion 22 is formed by fusing the first portion 21 and the third portion 23.

For example, the refractive index of the core at the first portion 21, the refractive index of the core at the second portion 22, and the refractive index of the core at the third portion 23 are equal to each other; the refractive index of the cladding at the first portion 21 is smaller than the refractive index of the cladding at the third portion 23; and the refractive index of the cladding at the second portion 22 increases from the first portion 21 side toward the third portion 23 side.

Or, the refractive index of the cladding at the first portion 21, the refractive index of the cladding at the second portion 22, and the refractive index of the cladding at the third portion 23 are equal to each other; the refractive index of the core at the first portion 21 is larger than the refractive index of the core at the third portion 23; and the refractive index of the core at the second portion 22 decreases from the first portion 21 side toward the third portion 23 side.

In the case where the laser is condensed to the state of a beam waist diameter D7, the laser has a characteristic of spreading at the spread angle α. That is, if one of the spread angle or the beam diameter is determined, the other also is determined necessarily.

A method in which a rare earth such as erbium, germanium, or the like is added to quartz glass is known as a method for providing a refractive index difference between the core and the cladding; and the core, the cladding, or both are examples of the object of the adding. The refractive index can be adjusted by the added substance and/or the concentration in the quartz glass. The refractive index of the core and the refractive index of the cladding each are not less than about 1.4 and not more than about 1.6 at each of the first portion 21, the second portion 22, and the third portion 23. Because the NA (the aperture) that can be incident is determined by the refractive index difference between the core and the fiber, for the fiber used in the first portion 21, it is necessary to use a fiber having a refractive index difference such that the NA is not less than the spread angle α of the laser incident on the first portion 21 and the spread angle of the beam.

If the spread angle is determined, the incident diameter also is determined; therefore, it is necessary to use a fiber having a MFD (a mode field diameter) matching the incident beam diameter and matching the refractive index difference.

It is desirable for the lengths in the central-axis direction of the first portion 21 and the third portion 23 each to be 100 μm or more to ensure a distance for the incident light to settle into a single mode; and it is desirable to adjust the second portion 22 to be disposed at the center vicinity of the through-hole 88 of the block 80.

In the block 80, the optical fiber 2 is fixed in the through-hole 88 using the elastic member (the bonding agent) 83a. A resin bonding agent such as epoxy, silicone, or the like is an example of a material suited to the bonding agent used as the elastic member 83a. For example, the elastic member 83a includes a high temperature-curing epoxy adhesive. The elastic member 83a is filled without leaving gaps in the space existing between the optical fiber 2 and the inner wall of the block 80 inside the through-hole 88 of the block 80. For example, the elastic member 83a is provided between the first portion 21 and the block 80 (the inner wall of the through-hole 88), between the second portion 22 and the block 80 (the inner wall of the through-hole 88), and between the third portion 23 and the block 80 (the inner wall of the through-hole 88).

Here, in the examples illustrated in FIG. 2 to FIG. 7, the fiber outer diameter D5 at the second portion 22 is smaller than the fiber outer diameter D4 at the first portion 21 and smaller than the fiber outer diameter D6 at the third portion 23; therefore, inside the through-hole 88, a gap occurs between the block 80 and the fiber outer perimeter at the second portion 22. The elastic member 83a is filled as a bonding agent into the gap without leaving gaps. Thereby, the elastic member 83a that is filled outside the fiber at the second portion 22 becomes a wedge for the fiber; and even in the case where the fiber stub 4 and the plug ferrule inserted into the optical receptacle 1 contact each other to perform the optical connection and an external force acts parallel to the axis direction, the movement of the fiber stub 4 or the optical fiber 2 in the axis direction is suppressed.

The second portion 22 is formed by fusing the first portion 21 and the third portion 23; therefore, according to the formation conditions, there are cases where the strength of the second portion 22 is lower than the strength of the first portion 21 or the strength of the third portion 23. Conversely, the second portion 22 can be reinforced by filling the elastic member 9 at the outer perimeter of the second portion 22.

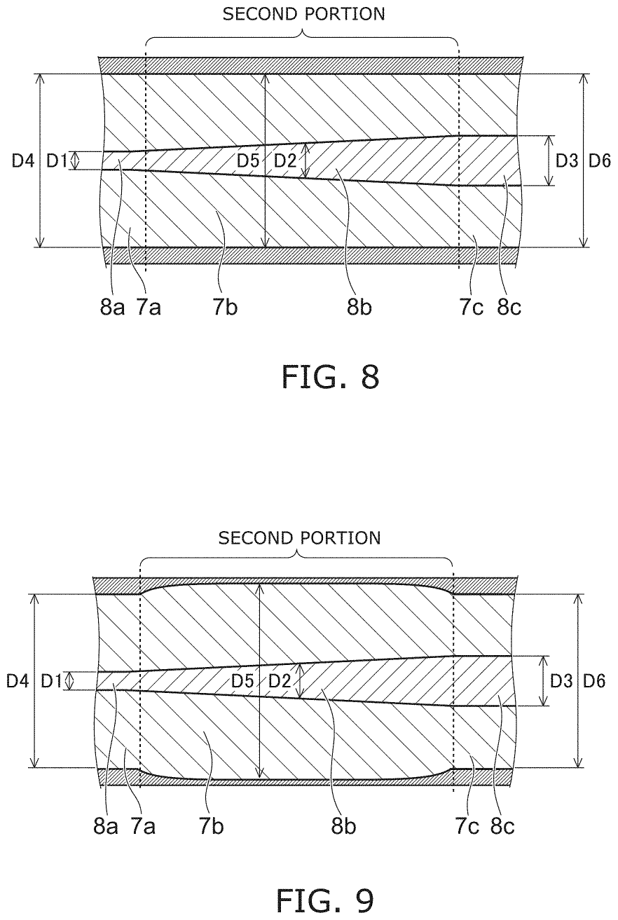

However, in the embodiment, the fiber outer diameter D5 at the second portion 22 may not always be smaller than the fiber outer diameter D4 at the first portion 21 or the fiber outer diameter D6 at the third portion 23. The configuration of the optical fiber 2 may be like the examples shown in FIG. 8 and FIG. 9.

FIG. 8 and FIG. 9 are schematic cross-sectional views illustrating a portion of the optical receptacle according to the first embodiment. The periphery of the second portion 22 is enlarged in these drawings.

In the example of FIG. 8, the fiber outer diameter D5 at the second portion 22 is substantially the same as the fiber outer diameter D4 at the first portion 21 or the fiber outer diameter D6 at the third portion 23. By providing such a configuration, the control of the electric discharge amount and/or the electric discharge timing can be relatively simple when forming the optical fiber 2 by fusing. In the example of FIG. 9, the fiber outer diameter D5 at the second portion 22 is larger than the fiber outer diameter D4 at the first portion 21 and larger than the fiber outer diameter D6 at the third portion 23. By providing such a configuration, the strength of the fused portion can be increased.

Normally, in the optical receptacle 1, to prevent reflections of the light at the end surface 2a of the optical fiber 2 (referring to FIG. 3) when the light is incident on the optical fiber 2 or when the light is emitted from the optical fiber 2, the end surface 2a of the optical fiber 2 is polished to be a flat surface substantially perpendicular to the central axis C1 (the direction X1) at the end surface 3a on the side of the fiber stub 4 opposite to the end surface 3b polished into the convex spherical surface. Here, it is desirable for substantially perpendicular to be about 85 degrees to 95 degrees with respect to the central axis C1.

In the example shown in FIG. 3, etc., the end surface 2a of the optical fiber 2 is polished into a flat surface perpendicular to the central axis C1; further, the end surface 2a of the optical fiber 2 and the second surface F2 of the block 80 exist in substantially the same plane. Here, it is desirable for substantially the same plane to be such that the distance along the direction of the central axis C1 between the end surface 2a of the optical fiber 2 and the second surface F2 of the block 80 is about −250 nm to +250 nm.

At the end surface 3a on the side of the fiber stub 4 opposite to the end surface 3b polished into the convex spherical surface, the center of the core 8 of the optical fiber 2 exists within a range of 0.005 millimeters (mm) from the center of the through-hole 88. Thereby, by controlling the position of the core 8 of the optical fiber 2, the connection loss when assembling the optical module can be small; and the optical module can be assembled easily.

Although the convex spherical surface of the fiber stub 4 normally is formed in a plane perpendicular to the central axis C1 of the ferrule 3, the convex spherical surface may be formed in a plane tilted a prescribed angle (e.g., 4 degrees to 10 degrees) from the plane perpendicular to the central axis C1 of the ferrule 3.

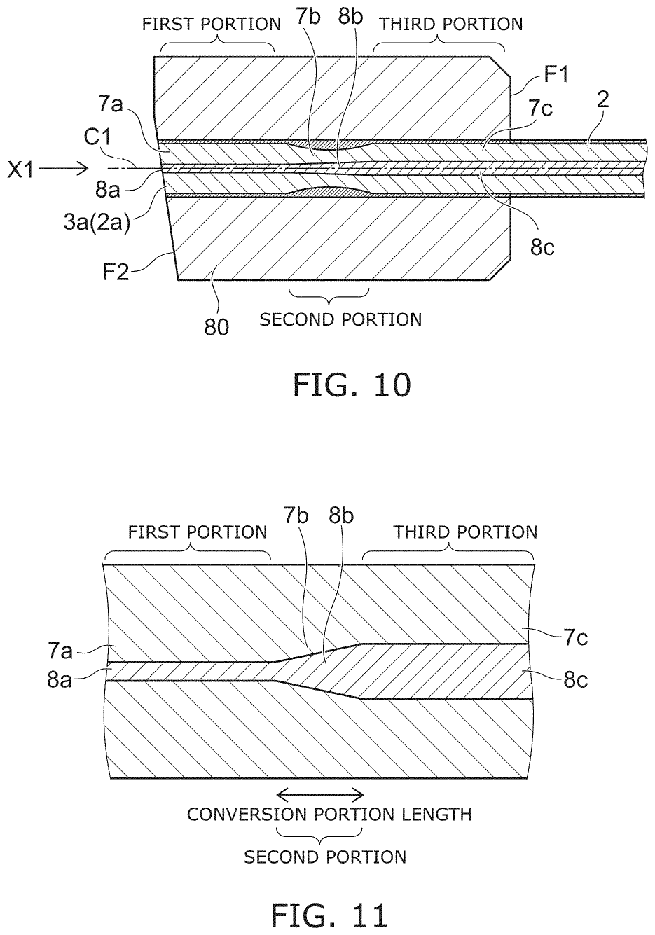

FIG. 10 is a schematic cross-sectional view illustrating a portion of the optical receptacle according to the first embodiment. The members that are included in the optical receptacle illustrated in FIG. 10 are similar to those of the optical receptacle 1 described in reference to FIGS. 1 to 9. In the example shown in FIG. 10, the end surface 2a of the optical fiber 2 (the end surface 3a on the block 80 side) is polished into a flat surface tilted a prescribed angle (e.g., 4 degrees to 10 degrees) from a plane perpendicular to the central axis C1 (the direction X1).

Thereby, the light that is emitted from the light-emitting element connected to the optical receptacle 1, is incident on the optical fiber 2, and is reflected by the end surface 2a of the optical fiber 2 can be prevented from returning to the light-emitting element; and the optical element can be operated stably.

For example, to form a surface having a prescribed angle from a plane perpendicular to the central axis C1, the block 80 and the optical fiber 2 are polished simultaneously after inserting the optical fiber 2 into the through-hole 88 of the block 80 and fixing the optical fiber 2 with a bonding agent.

For example, the elastic member (the bonding agent) 83a is filled at the outer perimeter of the portion where the fiber outer diameter at the second portion 22 is fine to fix the optical fiber 2 inside the through-hole 88 of the block 80. Therefore, even in the case where a force parallel to the central axis C1 acts on the optical fiber 2, the elastic member acts as a wedge; the shift in the central-axis direction of the fiber can be suppressed; therefore, the loss due to contact defects, and the phenomenon of the fiber jutting from the block do not occur easily.

An investigation relating to the core diameter and the refractive index of the optical fiber at the first portion 21 and the length in the central-axis direction of the second portion 22 performed by the inventor will now be described with reference to the drawings.

FIG. 11 to FIG. 13B are schematic views illustrating an example of analysis conditions and analysis results used in the investigation.

First, the core diameter will be described.

FIG. 11 is a schematic cross-sectional view illustrating the optical fiber used in the investigation.

In the case where a beam that has a beam waist having a diameter w1 is incident on a fiber having a MFD having a diameter w2, it is known that a coupling efficiency η is determined using the following formula when assuming that there is no axial misalignment in the optical axis perpendicular direction, angle deviation, or misalignment in the optical-axis direction.

$$η = \frac{4}{{( \frac{w 1}{w 2} + \frac{w 2}{w 1} )}^{2}} \qquad [ Formula 1 ]$$

According to this theoretical formula, it can be seen that the efficiency is 1 (100%) when w1=w2 when the beam waist of the laser and the MFD of the fiber match. Also, for a core diameter in the range of 0 to 10 μm, it is known that the MFD of a single-mode fiber fluctuates according to the wavelength; but the MFD has a diameter of 0.5 to 4 μm larger than the core diameter of the fiber. Due to this fact, it is desirable for the core diameter of the fiber to be about 0.5 to 4 μm smaller than the incident beam waist.

The refractive index difference will now be described. For the light to propagate through the single-mode fiber, it is desirable for a spread angle θ1 of the light and a light acceptance angle θ2 of the fiber to match. It is known that θ1 is determined using the following formula.

$$θ 1 = {tan}^{- 1} ( \frac{λ}{π w 1} ) = \frac{λ}{π w 1} \qquad [ Formula 2 ]$$

According to this formula, the spread angle θ1 can be determined if the beam waist w1 of the incident laser beam is known. Also, the light acceptance angle θ2 of the fiber is as shown in

θ2=sin⁻¹\sqrt{n_{core}²−n_{clad}²} [Formula 3]

and is known to be determined from the refractive index n_{core} of the core and the refractive index n_{clad} of the cladding.

If the incident beam waist w1 is determined, the spread angle of the beam also is determined; therefore, the refractive index difference between the core and the cladding of the fiber are determined so that θ2=θ1. For example, in the case where quartz glass is used as the core and the cladding, the refractive indexes of the core and the cladding transition in a range of about 1.4 to 1.6.

The length in the central axis C1-direction of the second portion 22 will now be described. Light CAE analysis was performed to confirm the effects of different lengths. In the investigation, the core diameter D1 of the first portion 21 was set to 3 μm; the refractive index of the first core portion 8a was set to 1.49; the core diameter D3 of the third portion 23 was set to 8.2 μm; the refractive index of the third core portion 8c was set to 1.4677; the total fiber length was set to 1000 μm; the refractive indexes of the cladding (7a, 7b, and 7c) of the portions were set to the same 1.4624; and the beam waist diameter D7 of the incident beam was set to 3.2 μm. Under these conditions, how the light intensity changes was calculated for when the length in the central axis C1-direction of the second portion 22 is changed 100 μm at a time from 0 μm to 500 μm. The length of the first portion 21 and the length of the third portion 23 each were set to (1000 μm−second portion 22 length)÷2.

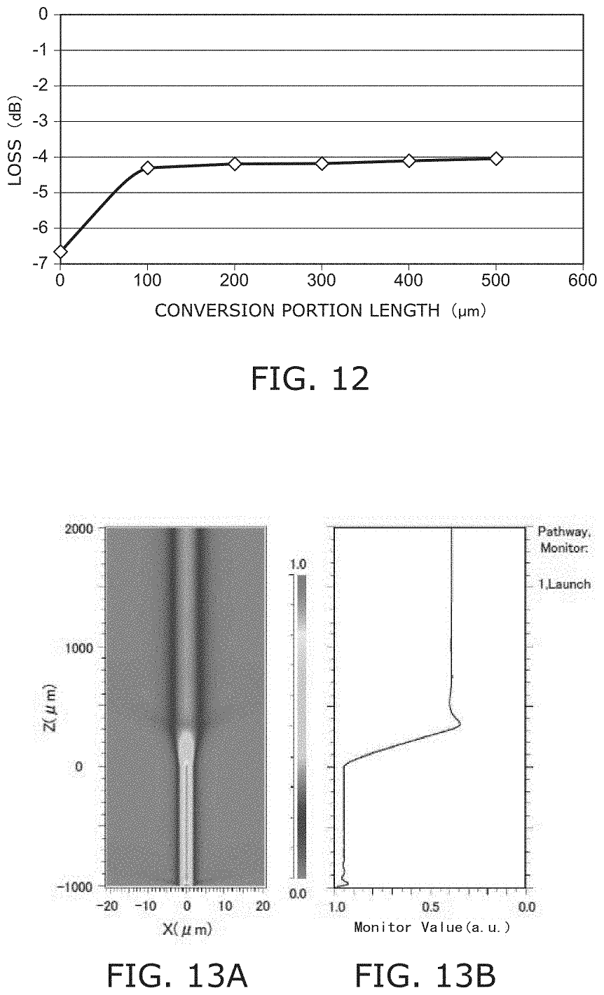

A graph in which the analysis results of the analysis are summarized is shown in FIG. 12. The horizontal axis is the length in the central axis C1-direction of the second portion 22; and the vertical axis is a logarithmic display of the intensity of the light at the fiber emission end when the incident light is taken to be 1. According to the analysis results, the loss in the interior of the optical fiber 2 decreases as the length in the central axis C1-direction of the second portion 22 lengthens. The state of the change is such that the loss is reduced abruptly by increasing the length from 0 to 100 μm; and the loss is substantially flat for 100 μm or more. Thereby, it is considered that it is desirable for the length of the second portion 22 along the central axis C1 (the direction X1) to be 100 μm or more.

FIG. 13A and FIG. 13B show a contour diagram and a graph of the light intensity distribution inside the fiber for an example of the analysis conditions. The vertical axis of the graph shows the distance from the incident end of the fiber; and the horizontal axis is the intensity of the light. The graph deserves special mention in that the light substantially does not attenuate when propagating through the first portion 21 and the third portion 23. The intensity of the incident light decreases due to the initial interference of the light but is stable after propagating somewhat from the emission end. Subsequently, the light enters the second portion 22 while maintaining a constant intensity. In the second portion 22, the light intensity decreases due to the loss occurring due to the conversion of the MFD and the change of the refractive index; and the light subsequently enters the third portion 23. In the third portion 23, there is substantially no change of the intensity; and the intensity is maintained at a constant value to the emission end.

According to one embodiment of the invention, the lengths in the central axis C1-direction of the first portion 21 and the third portion 23 do not affect the attenuation; therefore, even when the lengths of the first portion 21 and the third portion 23 are changed, the function of the fiber and the loss of the entire fiber are not affected. In other words, the lengths of the first portion 21 and the third portion 23 can be designed to be any length by the designer; and the dimensional tolerance of the design dimensions can be large. For this advantage, exact dimensional precision such as that of a GI fiber or a lens-attached fiber is unnecessary; and this advantage can contribute greatly to the improvement of the suitability for mass production.

An investigation relating to the length of the first portion 21 along the central axis C1-direction and the length of the third portion 23 along the central axis C1-direction will now be described.

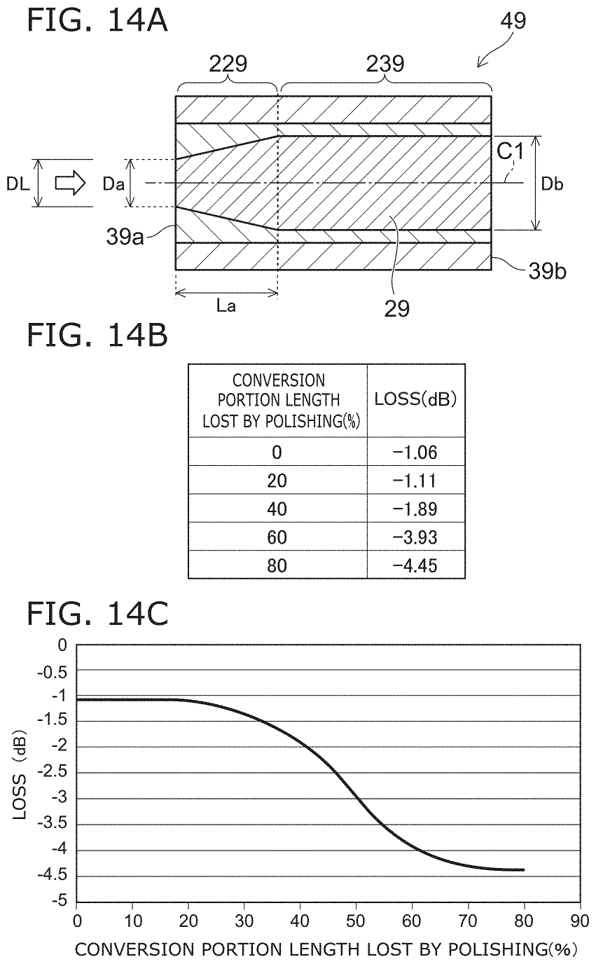

FIG. 14A to FIG. 14C are schematic views illustrating an example of an optical receptacle and analysis results of the optical receptacle for a reference example used in an investigation relating to the length of the first portion.

The optical receptacle of the reference example includes a fiber stub 49 shown in FIG. 14A. The structure of the fiber stub 49 of the reference example is similar to the structure of the fiber stub 4 according to the embodiment in which the first portion 21 (the first cladding portion 7a and the first core portion 8a) is not provided.

The fiber stub 49 includes an optical fiber 29. The fiber stub 49 has an end surface 39b connected to the plug ferrule, and an end surface 39a on the side opposite to the end surface 39b. The optical fiber 29 also includes a second portion 229 (a conversion portion) and a third portion 239. The third portion 239 is arranged in the axis direction with the second portion 229 and is continuous with the second portion 229. The second portion 229 forms at least a portion of the end surface 39a; and the third portion 239 forms at least a portion of the end surface 39b. The core diameter at the second portion 229 enlarges in the central-axis direction toward the third portion 239. The core diameter at the third portion 239 is substantially constant in the central-axis direction. In FIG. 14A, some of the components such as the elastic member, etc., are not illustrated for convenience.

Generally, the end surface 39a is polished into a mirror surface. Also, the end surface 39b is polished into a convex spherical configuration. The loss of the light at the end surfaces 39a and 39b can be suppressed thereby. In the optical receptacle, it is desirable to polish the end surfaces also from the perspectives of the connection between the optical element and the optical receptacle and the removal of the adhered bonding agent.

The polishing amount of the end surface 39a is, for example, not less than 5 μm and not more than 50 μm. Thereby, the mirror surface-like end surface can be formed.

Here, for the fiber stub 49 shown in FIG. 14A, for example, in the case where the end surface 39a is polished about 5 to 50 μm, the length of the second portion 229 becomes shorter according to the polishing amount. In other words, according to the polishing amount, the end surface position of the second portion 229 (the position of the portion of the second portion 229 exposed as the end surface 39a) fluctuates about 5 to 50 μm. That is, a core diameter Da at the end surface 39a fluctuates. This causes a loss when using a fiber in which the MFD changes periodically such as a GI fiber or the like.

The inventor of the application performed an analysis of the relationship between the loss and the polishing of the end surface 39a such as that recited above. An example of the analysis results is shown in FIG. 14B and FIG. 14C. In the investigation, before polishing of the end surface 39a, a length La along the axis direction of the second portion 229 was set to 50 μm; the core diameter Da at the end surface 39a was set to 3 μm; and a core diameter Db at the end surface 39b was set to 9 μm. The change rate along the axis direction of the core diameter at the second portion 229 was taken to be constant.

FIG. 14B illustrates the loss (dB) in the case where the length La is shortened by polishing the end surface 39a by 20% (a polishing amount of 10 μm), 40% (a polishing amount of 20 μm), 60% (a polishing amount of 30 μm), or 80% (a polishing amount of 40 μm) for the fiber stub 49 such as that recited above. FIG. 14C is a graph illustrating the data of FIG. 14B. Here, the loss (dB) is calculated from the intensity of the light at the emission end (the end surface 39b) in the case where the light (the diameter DL=3 μm) enters from the end surface 39a.

Before the polishing of the end surface 39a is performed, the loss is −1.06 dB. From the graph, it can be seen that the loss increases as the second portion 229 is shortened by the polishing. For example, the loss becomes about −3 dB when a conversion portion (the second portion 229) becomes 50% shorter due to the polishing.

Thus, in the reference example in which the first portion is not provided, the loss is undesirably increased by polishing the end surface. Also, in the reference example, even in the case where the core diameter at the end surface before polishing is determined by considering the polishing amount beforehand, the loss fluctuates according to the fluctuation of the polishing amount. It becomes necessary to strictly control the polishing amount; and the suitability for mass production may decrease.

Conversely, in the optical receptacle according to the embodiment, the first portion is provided in which the core diameter and the refractive index substantially do not change along the central axis C1. Even in the case where the length of the first portion along the central axis C1 fluctuates due to the polishing of the end surface 3a, the increase of the optical loss and the change of the fluctuation are small. For example, even in the case where the end surface position is changed within the range of the length of the first portion, the characteristics of the optical receptacle substantially do not degrade.

Thus, it is desirable for the length of the first portion along the central axis C1 to be not less than the polishing amount of the end surface 3a. As described above, to provide the end surface 3a with the mirror surface, the end surface 3a is polished by an amount that is not less than about 5 μm and not more than about 50 μm. Accordingly, it is desirable to include the length of the first portion along the central axis C1 (the direction X1) to be not less than 5 μm and if possible, it is more desirable to be 50 μm or more. Also, it is desirable for the length of the first portion along the central axis C1 to be 10 mm or less. The upper limit of the length of the first portion along the central axis C1 is not particularly limited; but it is desirable that the second portion and a portion of the third portion can be disposed inside the through-hole 88 of the block 80. To this end, according to the total length of the block 80, the first portion may be elongated to about 7 to 10 mm. The suitability for mass production can be improved thereby.

For example, the description relating to FIG. 14A to FIG. 14C is similar also for a reference example that does not include the third portion. In other words, in such a case, the core diameter at the end surface connected to the plug ferrule changes according to the polishing amount. The loss is increased by changing the core diameter at the end surface. Conversely, in the optical receptacle according to the embodiment, the third portion is provided in which the core diameter and the refractive index substantially do not change along the central axis C1. Even in the case where the length of the third portion along the central axis C1 fluctuates due to the polishing of the end surface 3b, the increase of the optical loss and the change of the fluctuation are small.

Thus, it is desirable for the length of the third portion along the central axis C1 to be not less than the polishing amount of the end surface 3b. For example, because the end surface 3b has the convex spherical configuration, the end surface 3b is polished an amount that is not less than about 5 μm and not more than about 20 μm. Accordingly, it is desirable for the length of the third portion along the central axis C1 (the direction X1 or X2) to be 5 μm or more, and if possible, more desirably 20 μm or more. The upper limit of the length of the third portion along the central axis C1 is not particularly limited; but it is desirable that the first portion and the second portion can be disposed inside the through-hole 88 of the block 80. The length of the third portion along the central axis C1 can be set to, for example, a length to the PC (Physical Contact) surface.

According to the embodiment as described above, the core diameter D1 at the end surface 3a on the side of the fiber stub 4 opposite to the end surface 3b polished into the convex spherical surface is smaller than the core diameter D3 at the end surface 3b polished into the convex spherical surface; therefore, the loss at the optical connection surface (e.g., the connection surface between the optical element and the optical fiber) can be suppressed; and the length of the optical module can be shortened. For example, a lens for condensing, etc., may not be provided between the optical fiber and the optical element such as a semiconductor laser element, etc.

Also, by forming the second portion 22, the optical loss at the second portion 22 can be suppressed because an abrupt change of the core shape can be suppressed when transitioning from the first portion 21 to the third portion 23.

The configuration of the first portion 21 and the configuration of the third portion 23 do not change in the central-axis direction of the optical fiber 2; and the loss of the light at the first portion 21 and the third portion 23 is small; therefore, in the case where the second portion 22 is provided inside the through-hole of the block, the second portion 22 may be located anywhere inside the through-hole. Thereby, the precise length control of the optical fiber 2 is unnecessary; and the optical receptacle can be manufactured economically. This is similar also for the case where the optical fiber 2 is provided on the V-shaped groove described below.

Because the fiber outer diameter D5 at the second portion 22 is smaller than the diameter of the through-hole 88, the movement of the fiber in the central-axis direction can be deterred by filling the elastic member 83a into the gap.

The second portion 22 (the fused portion) can be protected from stress from the outside by causing the entire regions of the first portion 21 and the second portion 22 to conform to the block 80 and by fixing the first portion 21 and the second portion 22 using the elastic member 83a. Also, by causing the MFD of the optical element such as an optical integrated circuit or the like and the MFD of the block 80 interior to approach each other, a connection method (a butt-joint) is possible in which the block 80 is directly pressed onto the optical element while suppressing the coupling loss due to the MFD difference; and the optical devices between the optical element and the block 80 can be reduced. For example, in the case where light that has a diameter of 1 μm or less is emitted from the optical integrated circuit, the light can enter the optical fiber 2 without using a beam conversion device such as a lens, etc. Thereby, a cost reduction and a decrease of the loss due to the device alignment error are possible.

By fixing the optical fiber 2 in the through-hole, the number of component parts of the block 80 can be low (e.g., 1); and the assembly can be performed by inserting the optical fiber 2 into the block 80; therefore, the number of manufacturing processes can be reduced.

A method may be considered in which a second portion such as that described above is provided inside the ferrule 3. In such a case, the second portion is housed in the interior of the ferrule; therefore, the ferrule lengthens according to the length of the second portion. Also, the optical fiber of which the cover is removed is housed in the ferrule interior when fusing; therefore, the ferrule lengthens according to the length of the optical fiber of which the cover is removed when fusing. On the other hand, many standards such as connector standards, etc., are provided for the periphery of the ferrule. Therefore, it is considered that it may be difficult to design to comply with the standards if the ferrule lengthens.

The block 80 includes, for example, optical glass such as quartz glass, etc. The material of the block 80 may be, for example, a brittle material such as a ceramic, a metal material such as stainless steel, etc.

In the case where a transparent material such as optical glass or the like is used as the material of the block 80, ultraviolet can pass through the block 80; therefore, UV curing can be performed at the bottom surface of the block 80 when fixing the block 80 to a transceiver, etc. Also, for example, in the case where the second portion 22 (the MFD conversion portion) is provided inside the ferrule 3, etc., the periphery of the MFD conversion portion is covered with the ferrule 3, the holder 5, the sleeve 6, the housing portion 10, etc.; therefore, the MFD conversion portion cannot be confirmed by the naked eye, etc., from the outside. Conversely, for the optical receptacle 1 according to the embodiment, by using a transparent material as the block 80, the MFD conversion portion can be confirmed by the naked eye, etc., from the outside. For example, cracks, damage, etc., that occur in the MFD conversion portion formed by fusing can be confirmed by the naked eye, etc., from the outside.

In the case where a ceramic is used as the material of the block 80, the block can have various functions. For example, in the case where a ceramic having a low thermal expansion such as cordierite is used, the shift of the position of the block 80 with respect to the optical element such as an optical integrated circuit, etc., due to the temperature after bonding the block 80 can be suppressed.

In the case where a resin is used as the material of the block 80, the production cost can be suppressed to be low by manufacturing the block 80 using a high-precision mold with a resin as the material.

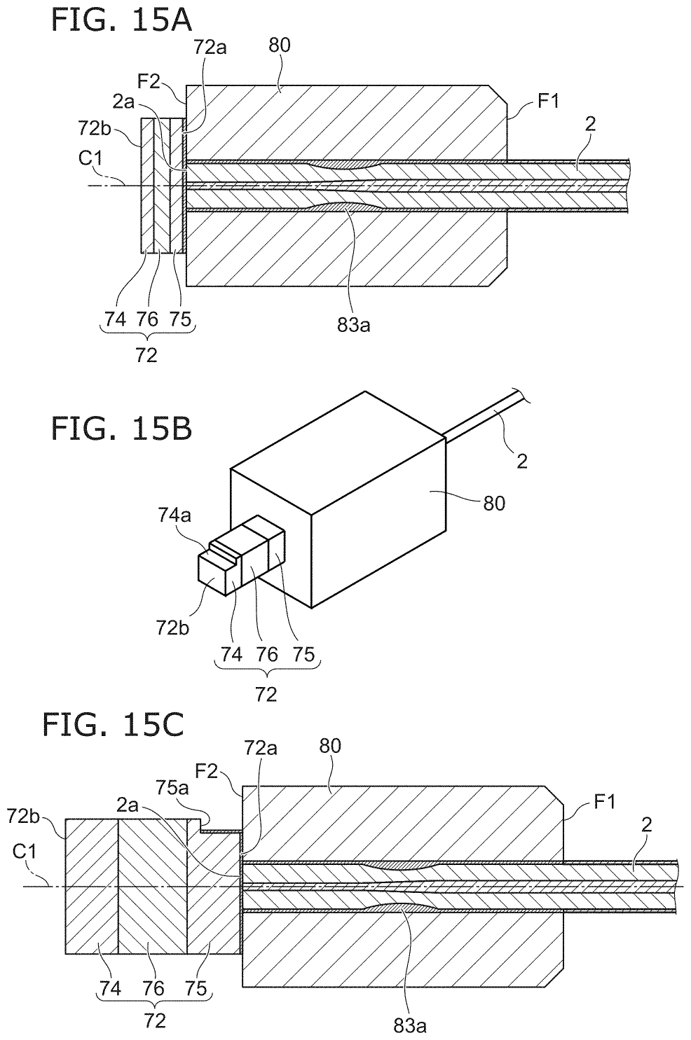

FIG. 15A to FIG. 15C are schematic cross-sectional views illustrating portions of the optical receptacle according to the first embodiment.

The periphery of the block 80 is enlarged in FIG. 15A to FIG. 15C.

In the example as illustrated in FIG. 15A, the optical receptacle 1 further includes a transparent member 72 disposed at the end surface 2a of the optical fiber 2 on the second surface F2 side of the block 80.

The elastic member 83a is filled into the gap between the through-hole of the optical fiber 2 and the block 80 and is filled, for example, between the transparent member 72 and the second surface F2 of the block 80. Thereby, the transparent member 72 is fixedly bonded to the block 80 by the elastic member 83a.

The end surface 2a of the optical fiber 2 on the side opposite to the side optically connected to the plug ferrule is closely adhered to the elastic member 83a. An end surface 72a of the transparent member 72 on the optical fiber 2 side is closely adhered to the elastic member 83a. The elastic member 83a and the transparent member 72 are transparent. Thereby, the light that is irradiated from the optical element enters the optical fiber 2 via the transparent member 72 and the elastic member 83a; and the light that is emitted from the optical fiber 2 enters the optical element via the transparent member 72 and the elastic member 83a.

In the example, the transparent member 72 is disposed outside the block 80 (on the optical element side of the second surface F2). At least a portion of the transparent member 72 may be provided inside the block 80 (the interior of the through-hole 88). The fixing strength of the transparent member 72 can be ensured thereby.

At least a portion of an end surface 72b of the transparent member 72 on the end surface 72b of the side opposite to the optical fiber 2 has a flat surface substantially perpendicular to the central axis C1 of the optical receptacle 1. Here, for example, substantially perpendicular is an angle of not less than about 85 degrees and not more than 95 degrees with respect to the central axis C1 of the optical receptacle 1.

A method that uses a polishing film having a diamond abrasive, etc., may be used to form the flat surface in the end surface 72b of the transparent member 72. Also, it is desirable for the surface roughness of the end surface 72b of the transparent member 72 to have an arithmetic average roughness of 0.1 micrometers or less to make the reflection amount of the light as small as possible.

It is desirable for the elastic member 83a and the transparent member 72 each to have substantially the same refractive index as the refractive index of the core of the optical fiber 2. Here, substantially the same refractive index is not less than about 1.4 and not more than about 1.6. The refractive index of the core of the optical fiber 2 is, for example, not less than about 1.46 and not more than about 1.47. The refractive index of the elastic member 83a is, for example, not less than about 1.4 and not more than about 1.5. The refractive index of the transparent member 72 is, for example, not less than about 1.4 and not more than about 1.6. Thereby, the reflections of the light at the interface between the transparent member 72 and the elastic member 83a and the interface between the elastic member 83a and the optical fiber 2 can be reduced; and the coupling efficiency of the optical module increases.

The material of the elastic member 83a closely adhered to the transparent member 72 may be different from the material of the elastic member 83a filled into the gap between the optical fiber 2 and the block 80. For example, an epoxy resin, an acrylic resin, a silicone resin, or the like is used as the material of the elastic member 83a closely adhered to the transparent member 72.

To reduce the reflections in an optical receptacle, generally, polishing is performed to form the end surface 2a of the optical fiber 2 into a mirror surface-like flat surface. Conversely, in the configuration illustrated in FIG. 15A, the reflections of the light at the end surface 2a can be reduced without similarly performing the polishing of the end surface 2a of the optical fiber 2.

For example, an isolator may be used as the transparent member 72. In the case where the transparent member 72 is an isolator, the transparent member 72 includes a first polarizer 74, a second polarizer 75, and a Faraday rotator 76. The Faraday rotator 76 is provided between the first polarizer 74 and the second polarizer 75. The Faraday rotator 76 includes, for example, a material such as garnet, etc.

For example, when the light that is emitted from the optical element enters the optical fiber 2, the first polarizer 74 transmits only linearly polarized light in a prescribed direction. The Faraday rotator 76 rotates the polarization plane of the linearly polarized light passing through the first polarizer 74 about 45°. The second polarizer 75 transmits only the linearly polarized light passing through the Faraday rotator 76. In other words, the polarization direction of the second polarizer 75 is rotated about 45° with respect to the polarization direction of the first polarizer 74. Thereby, the light that is emitted from the optical element and enters the optical fiber 2 can pass through in only one direction.

Thus, by mounting an isolator as the transparent member 72, the reflection at the end surface 72b of the light incident on the first portion from the optical element such as an optical integrated circuit, etc., or the light emitted from the first portion toward the optical element can be suppressed. Or, the reflected light can be suppressed from returning to the optical element; and the optical element can be operated stably. For example, an AR (anti-reflective) coating may be provided on the end surface 72b on the side of the transparent member 72 opposite to the optical fiber 2.

The block 80 has a substantially rectangular parallelepiped configuration. Similarly, the isolator (the transparent member 72) also has a substantially rectangular parallelepiped configuration. Accordingly, for example, compared to the case where an isolator is mounted to a circular columnar fiber stub 4, etc., the operation of aligning the isolator can be easy. For example, the polarization direction of the isolator can be easily mounted at the prescribed angle by using the block 80 as a reference. The shift of the angle of the polarization direction of the isolator can be suppressed; and the mounting can have high precision. Thereby, for example, the alignment in the rotation direction with the optical element can be easy; and the alignment time can be shortened.

In the example as illustrated in FIG. 15B, the first polarizer 74 of the transparent member 72 which is the isolator has a notch 74a. For example, the notch 74a is provided at one side surface (a surface parallel to the central axis C1) of the substantially rectangular parallelepiped first polarizer 74. For example, the notch 74a is continuous with the end surface 72b of the transparent member 72 on the side opposite to the optical fiber 2. In other words, the notch 74a is provided in one side surface of the first polarizer 74 and extends to the end surface 72b.

For example, the notch 74a is provided to be parallel to the polarization direction of the first polarizer 74. Thus, by providing the notch 74a in the first polarizer 74, the polarization direction of the first polarizer 74 can be visually confirmed easily. For example, the orientation of the optical element can be aligned easily when causing the light emitted from the optical element to be incident on the first polarizer 74. In other words, the alignment in the rotation direction with the optical element can be easy; and the alignment time can be shortened further.

In the example as illustrated in FIG. 15C, the second polarizer 75 of the transparent member 72 which is the isolator has a notch 75a. For example, the notch 75a is provided at one side surface of the substantially rectangular parallelepiped second polarizer 75 (a surface parallel to the central axis C1). For example, the notch 75a is continuous with the end surface 72a of the transparent member 72 on the optical fiber 2 side. In other words, the notch 75a is provided in one side surface of the second polarizer 75 and extends to the end surface 72a.

For example, the notch 75a is provided to be parallel to the polarization direction of the second polarizer 75. Thereby, similarly to the description recited above, the polarization direction of the second polarizer 75 can be visually confirmed easily. A shortening of the alignment time, etc., can be realized. Also, in the example, the elastic member 83a is filled between the transparent member 72 and the second surface F2 of the block 80; and a portion of the elastic member 83a enters the notch 75a. Thereby, the bonding strength between the transparent member 72 and the block 80 can be higher.

The configurations of the notches 74a and 75a are not limited to those recited above and may be any configuration that can indicate the polarization direction of the first polarizer 74 or the second polarizer 75. Also, for example, the notches may be provided in both the first polarizer 74 and the second polarizer 75. Or, a notch may be provided in the Faraday rotator 76.

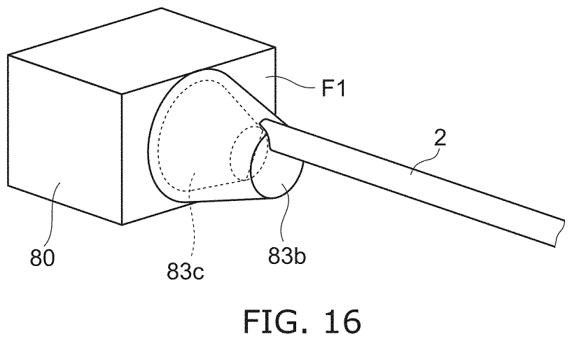

FIG. 16 is a schematic perspective view illustrating a portion of the optical receptacle according to the first embodiment. The periphery of the block 80 is enlarged in FIG. 16. In the example as illustrated in FIG. 16, the optical receptacle 1 further includes an elastic member (a second elastic member) 83b and an elastic member (a third elastic member) 83c. The elastic members 83b and 83c are provided on the first surface F1 side of the block 80 and are bonding agents bonding the optical fiber 2 to the block 80. The elastic members 83b and 83c include, for example, an epoxy resin, an acrylic resin, a silicone resin, etc. For example, substantially the same material as the material described in reference to the elastic member 9 can be used as the elastic members 83b and 83c.

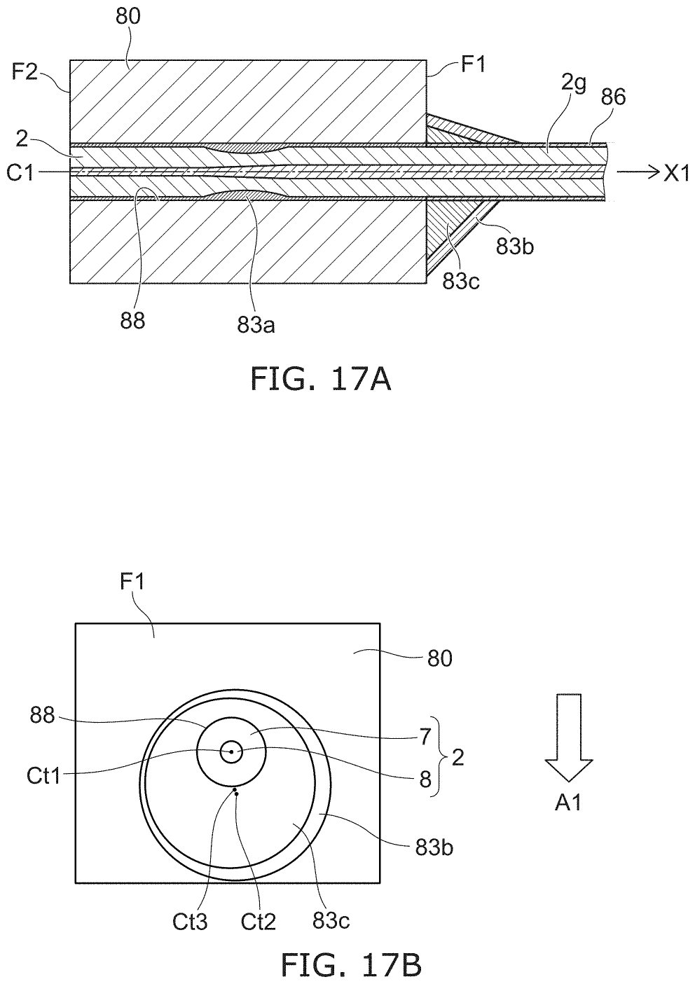

FIG. 17A and FIG. 17B are schematic views illustrating the portion of the optical receptacle according to the first embodiment.

FIG. 17A is a schematic cross-sectional view of the block 80 shown in FIG. 16.

As described above, the cover portion 86 that covers the portion 2g of the optical fiber 2 protruding from the first surface F1 is provided on the optical fiber 2. The elastic member 83b is provided between the cover portion 86 and the block 80. For example, the elastic member 83b contacts the cover portion 86 and the first surface F1. Thereby, the elastic member 83b bonds the optical fiber 2 to the first surface F1 side of the block 80.

The elastic member 83c is provided between the cover portion 86 and the block 80. For example, the elastic member 83c contacts the cover portion 86 and the first surface F1. Thereby, the elastic member 83c bonds the optical fiber 2 on the first surface F1 side of the block 80. The elastic member 83c also is positioned between the block 80 and the elastic member 83b. In the example, the elastic member 83c contacts the elastic member 83b and is covered with the elastic member 83b.

For example, the elastic member 83c may be continuous with the elastic member 83a provided inside the through-hole 88 of the block 80. The material of the elastic member 83c may be the same as the material of the elastic member 83a. For example, the elastic member 83c and the elastic member 83a may be one body and may be formed as one elastic member. In other words, the elastic member 83a may include a portion provided inside the through-hole 88 and a portion jutting from the through-hole 88 (the portion corresponding to the elastic member 83c).

Thus, by providing the elastic members 83b and 83c at the portion 2g of the optical fiber 2 protruding from the block 80, the stress that is applied from the outside to the portion 2g protruding from the block 80 can be reduced; and breakage of the optical fiber 2 can be suppressed. Also, by providing the elastic members 83b and 83c between the block 80 and the cover portion 86 covering the optical fiber 2, the cover portion 86 can be protected; and breakage of the cover portion can be suppressed.

The material of the elastic member 83b is softer than the material of the elastic member 83c. The elastic member 83b is, for example, a highly-elastic bonding agent. The elastic member 83c is a fiber-fixing bonding agent that fixes the base portion of the optical fiber 2 (the portion at the opening end periphery of the through-hole 88). The relatively hard elastic member 83c is provided at the base portion of the optical fiber 2; and the relatively soft and highly-elastic elastic member 83b is provided on the ferrule 3 side of the elastic member 83c. Thereby, the base portion of the optical fiber 2 where the stress concentrates easily can be protected by the hard elastic member 83c while the soft elastic member 83b relaxes the stress applied to the optical fiber 2.

FIG. 17B is a plan view the block 80, the optical fiber 2, and the elastic members 83b and 83c viewed along a direction parallel to the central axis C1 (the direction X1).

In the plan view of FIG. 17B, a center Ct1 of the through-hole 88 is different from a center Ct2 of the elastic member 83b and different from a center Ct3 of the elastic member 83c. Here, for example, the center is the centroid position of the planar configuration made of the outer edge of the elastic member or the optical fiber. The center Ct2 and the center Ct3 are positioned in the direction of arrow A1 (e.g., downward) when viewed from the center Ct1. The durability for the stress acting on the optical fiber 2 in the direction of arrow A1 improves thereby. Also, the spreading of the elastic member 83c (the bonding agent) over the entire first surface F1 when coating the elastic member 83c on the first surface F1 is prevented; and the region where the elastic member 83b (the bonding agent) is coated onto the first surface F1 is ensured easily.

In the embodiment, the center Ct1 may match at least one of the center Ct2 or the center Ct3. For example, the planar configuration of the elastic member may be point-symmetric with respect to the center Ct1. Thereby, the durability can be improved uniformly in all directions having the central axis as the center.

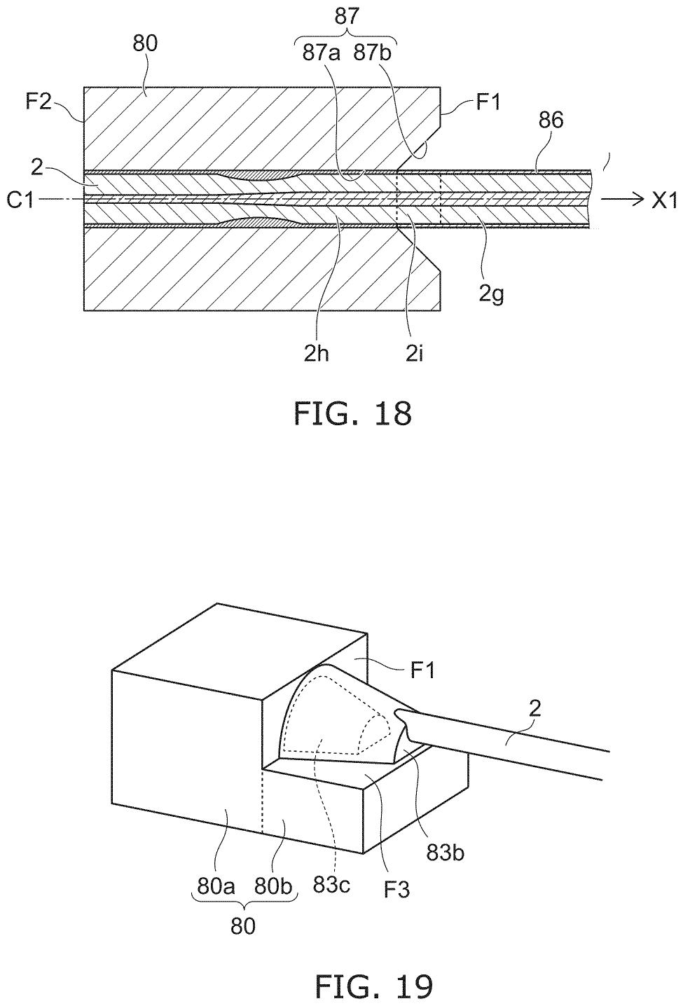

FIG. 18 is a schematic cross-sectional view illustrating a portion of the optical receptacle according to the first embodiment. The periphery of the block 80 is enlarged in FIG. 18. In the example illustrated in FIG. 18, the through-hole 88 of the block 80 has a small diameter portion 87a and an increasing-diameter portion 87b. The increasing-diameter portion 87b is provided on the first surface F1 side of the small diameter portion 87a. The diameter of the small diameter portion 87a is substantially constant in a direction along the central axis C1. The diameter of the increasing-diameter portion 87b is larger than the diameter of the small diameter portion 87a and increases toward the first surface F1 in the direction along the central axis C1. The diameter of the increasing-diameter portion 87b is the width in a direction orthogonal to the central axis C1.

The optical fiber 2 includes a portion 2h disposed inside the small diameter portion 87a, and a portion 2i disposed inside the increasing-diameter portion 87b. The cover portion 86 that covers the portion 2g of the optical fiber 2 protruding from the first surface F1 further covers the portion 2i of the optical fiber 2 disposed inside the increasing-diameter portion 87b.

For example, the elastic member 83a and/or the elastic member 83c can be filled between the cover portion 86 and the inner wall of the increasing-diameter portion 87b inside the increasing-diameter portion 87b. Thus, by fixing the cover portion 86 by the elastic member inside the increasing-diameter portion, the bonding strength and the reinforcing strength of the optical fiber can be increased; and breakage of the optical fiber 2 can be suppressed.

FIG. 19 is a schematic perspective view illustrating the portion of the optical receptacle according to the first embodiment.

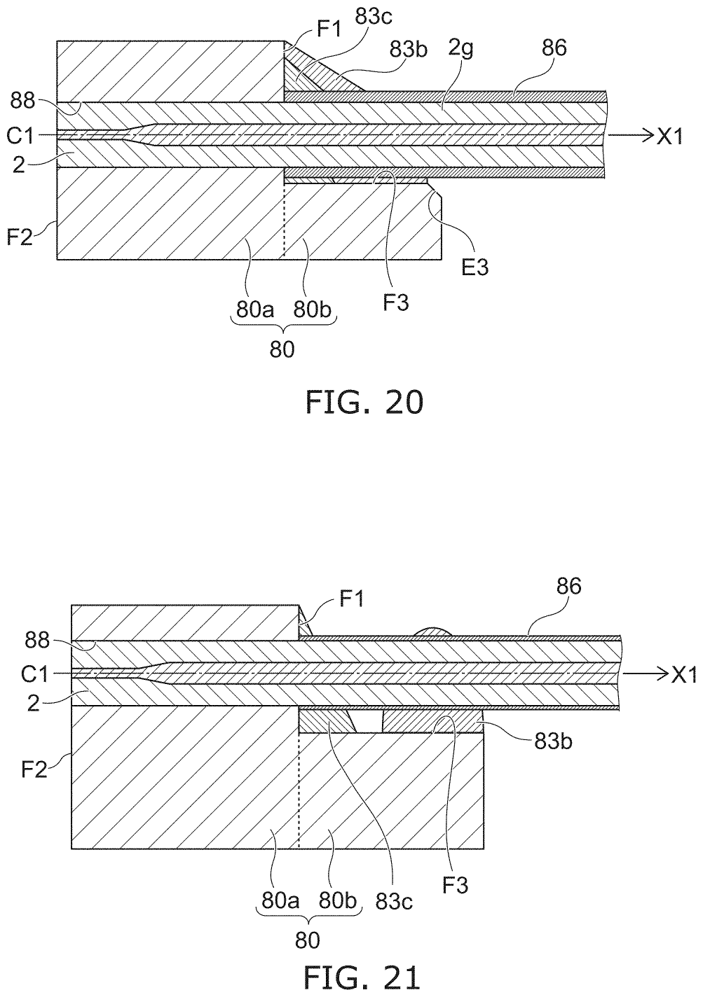

FIG. 20 is a schematic cross-sectional view illustrating the portion of the optical receptacle according to the first embodiment.

The periphery of the block 80 is enlarged in FIG. 19; and FIG. 20 illustrates a cross section of the block shown in FIG. 19.

In the example illustrated in FIG. 19 and FIG. 20, the block 80 includes a base portion 80a and a level-difference portion 80b. The first surface F1, the second surface F2, and the through-hole 88 are provided in the base portion 80a.

The level-difference portion 80b is the portion of the base portion 80a protruding from the first surface F1 side along the central axis C1 toward the ferrule 3 side. In other words, the level-difference portion 80b is arranged with the portion 2g of the optical fiber 2 protruding from the first surface F1 in a direction perpendicular to the central axis C1.

The level-difference portion 80b has a third surface F3 opposing the optical fiber 2. The third surface F3 is, for example, a flat surface perpendicular to the first surface F1. The elastic member 83b and the elastic member 83c each are disposed between the third surface F3 and the cover portion 86 of the optical fiber 2. For example, the elastic member 83b and the elastic member 83c each contact the third surface F3. Thereby, the coated surface area of the bonding agent can be wider. In other words, it is possible to fixedly bond the optical fiber 2 and the cover portion 86 to the third surface F3 of the level-difference portion 80b. Thereby, bending stress can be prevented from concentrating at the interface between the optical fiber 2 and the block 80. For example, the starting point of the bend of the optical fiber 2 can be shifted toward an end portion E3 side of the third surface F3 on the ferrule 3 side. The undesirable direct application of a force in the bending direction on the portion of the optical fiber 2 exposed from the cover portion 86 can be suppressed thereby. Breakage of the optical fiber 2 can be suppressed further. Accordingly, the bonding strength and the reinforcing strength of the optical fiber 2 can be improved further. As illustrated in FIG. 21, the elastic member 83b may be separated from the elastic member 83c and the first surface F1. The stress that is applied to the optical fiber 2 is relaxed by the elastic member 83b bonding the third surface F3 and the cover portion 86.

At least a portion of the end portion of the level-difference portion 80b is beveled. For example, the level-difference portion 80b includes the end portion E3 positioned at the end of the third surface F3 on the ferrule 3 side. The end portion E3 is formed by beveling the corner of the level-difference portion 80b. “Beveled” is the state in which the corner of the end portion E3 is not acute and is, for example, obtuse. Or, the surface of the end portion E3 may be curved. In the case where the optical fiber 2 and/or the cover portion 86 contact the end portion E3, the contact portion can be suppressed from becoming a starting point of breakage of the optical fiber 2 and/or breakage of the cover portion 86.

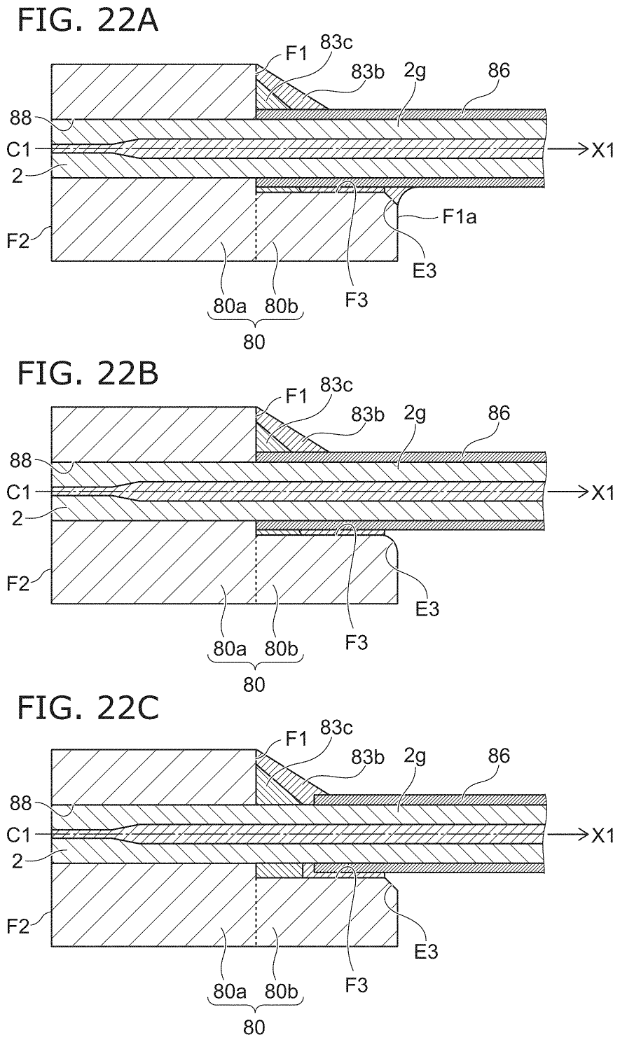

FIG. 22A to FIG. 22C are schematic cross-sectional views illustrating portions of the optical receptacle according to the first embodiment.

As illustrated in FIG. 22A, by setting the end portion E3 of the level-difference portion 80b of the block 80 to have a tilted surface configuration tilted downward in the straight line configuration toward the ferrule 3 side, the undesirable outflow of the elastic member 83b and/or the elastic member 83c (the bonding agent) onto an end surface Fla of the level-difference portion 80b facing the ferrule 3 side can be suppressed. For example, the linear tilted end portion E3 suppresses the undesirable outflow of the elastic member 83b and/or the elastic member 83c to the end surface Fla by surface tension.

For example, there is a possibility that the end surface Fla may be used as a positional alignment surface for determining the positions of the optical fiber 2 and the block 80 in a fixing process of fixing the optical fiber 2 to the block 80, etc. In such a case, if the elastic member 83b and/or the elastic member 83c outflows onto the end surface Fla and the elastic member 83b and/or the elastic member 83c undesirably covers the end surface Fla, the precision of the positional alignment of the optical fiber 2 and the block 80 is undesirably affected.

Accordingly, as recited above, the end portion E3 has a linear tilted surface configuration; and the undesirable outflow of the elastic member 83b and/or the elastic member 83c onto the end surface Fla is suppressed. Thereby, when using the end surface Fla as a positional alignment surface, the undesirable effects of the elastic member 83b and/or the elastic member 83c on the precision of the positional alignment can be suppressed.

As illustrated in FIG. 22B, the end portion E3 of the level-difference portion 80b of the block 80 may have a convex curved configuration. In such a case, for example, it is favorable for the end portion E3 to have a convex curved configuration having a radius of about 0.1 mm to 3 mm. Thereby, for example, in the case where the optical fiber 2 and/or the cover portion 86 contacts the end portion E3, the contact portion can be suppressed from becoming a starting point of breakage of the optical fiber 2 and/or breakage of the cover portion 86. In the case where the optical fiber 2 and/or the cover portion 86 contacts the end portion E3, the stress concentration at the optical fiber 2 and/or the cover portion 86 can be suppressed more reliably.

As illustrated in FIG. 22C, the end portion of the cover portion 86 on the block 80 side may be separated from the first surface F1 of the block 80. Thereby, for example, the control of the dimension of the length of the cover portion 86 can be easy. It is unnecessary to strictly set the length of the cover portion 86 in a direction parallel to the central axis C1; and the optical receptacle 1 can be manufactured easily.

In the case where the end portion of the cover portion 86 on the block 80 side is separated from the first surface F1 of the block 80, it is favorable for the end portion of the cover portion 86 on the block 80 side to be covered with at least one of the elastic member 83b or the elastic member 83c as illustrated in FIG. 22C. In other words, it is favorable for the portion of the optical fiber 2 exposed between the first surface F1 and the cover portion 86 to be covered with at least one of the elastic member 83b or the elastic member 83c. Thereby, even in the case where the end portion of the cover portion 86 on the block 80 side is separated from the first surface F1 of the block 80, the undesirable damage of the portion of the optical fiber 2 exposed from the cover portion 86 can be suppressed.

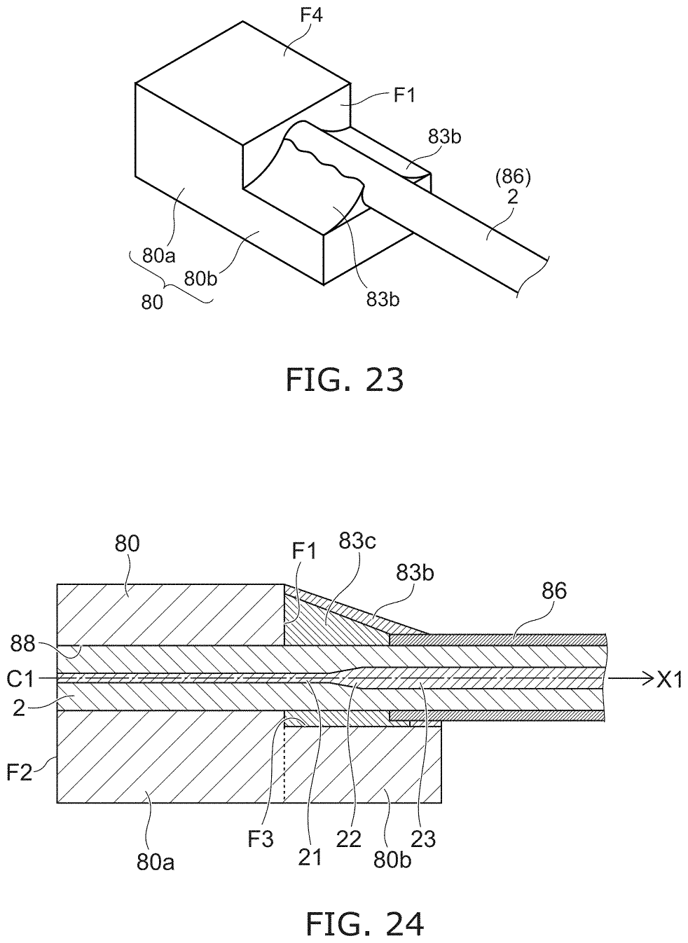

FIG. 23 is a schematic perspective view illustrating a portion of the optical receptacle according to the first embodiment.

In the example as illustrated in FIG. 23, the elastic member 83b is provided on both the left and right sides of the optical fiber 2 and the cover portion 86. In the example, the elastic member 83b is provided only at the portions lower than the upper ends of the optical fiber 2 and the cover portion 86. In other words, the elastic member 83b is not provided higher than the optical fiber 2 and the cover portion 86. The elastic member 83b does not cover the tops of the optical fiber 2 and the cover portion 86.

Thus, the elastic member 83b and the elastic member 83c may be provided only at portions lower than the upper ends of the optical fiber 2 and the cover portion 86. Thereby, for example, the height of the base portion 80a of the block 80 can be suppressed. Also, for example, the undesirable flow of the elastic member 83b and/or the elastic member 83c onto a fourth surface F4 of the base portion 80a facing the same direction as the third surface F3 can be suppressed. For example, when the fourth surface F4 is used as a positional alignment surface, etc., the undesirable effects of the elastic member 83b and/or the elastic member 83c on the precision of the positional alignment can be suppressed.

FIG. 24 is a schematic cross-sectional view illustrating a portion of the optical receptacle according to the first embodiment. The periphery of the block 80 is enlarged in FIG. 24. The position of the second portion 22 in the optical receptacle illustrated in FIG. 24 is different from that of the optical receptacle described in reference to FIG. 20.

In the example, the second portion 22 and the third portion 23 protrude from the first surface F1 toward the ferrule 3 side. In other words, the position of the first surface F1 in the direction X1 is between the positions of the second portion 22 and the third portion 23 in the direction X1 and the position of the second surface F2 in the direction X1.

At least a portion of the first portion 21 is positioned between the first surface F1 and the second surface F2 in the direction X1. In other words, the position of at least a portion of the first portion 21 in the direction X1 is between the position of the first surface F1 in the direction X1 and the position of the second surface F2 in the direction X1.

Even if the diameter of the cladding at the second portion 22 changes when fusing the optical fiber, only the first portion 21 conforms to the through-hole 88 (or the V-shaped groove described below) of the block 80. For example, the diameter of the first portion 21 is the same over the entire region of the first portion 21. Therefore, the optical fiber 2 can be fixed to the block 80 without affecting the positional relationship between the block 80 and the core 8.

For example, the elastic member 83c is provided between a portion of the first portion 21 and the third surface F3 of the block 80, between the second portion 22 and the third surface F3 of the block 80, and between the third surface F3 of the block 80 and a portion of the third portion 23. Thereby, the second portion 22 can be protected by the elastic member 83c.

### Second Embodiment

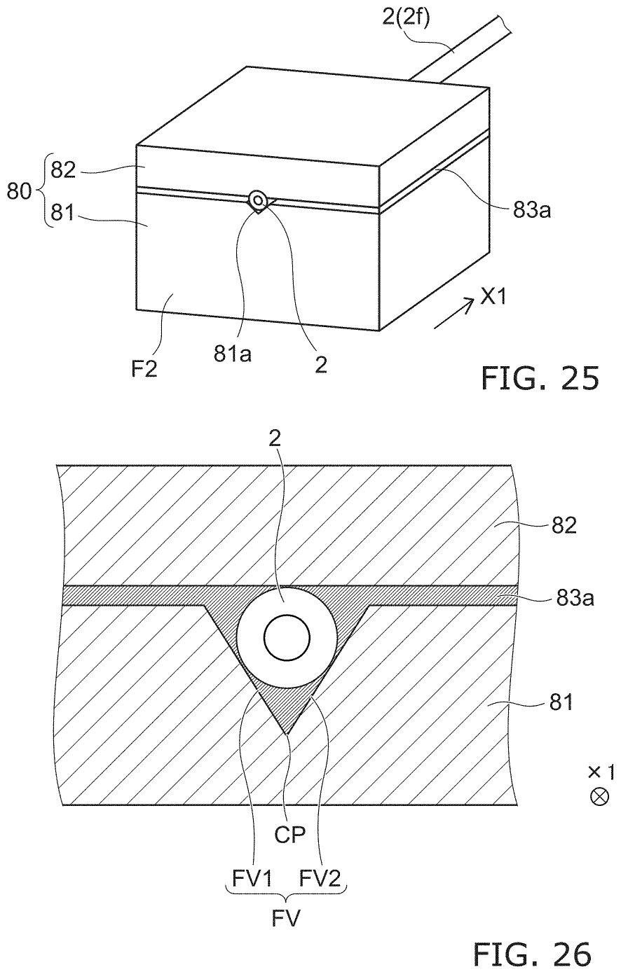

FIG. 25 is a schematic perspective view illustrating a portion of an optical receptacle according to a second embodiment.

FIG. 26 is a schematic cross-sectional view illustrating the portion of the optical receptacle according to the second embodiment.

The periphery of the block 80 of the optical receptacle is enlarged in FIG. 25; and a cross section orthogonal to the central axis C1 of the optical fiber 2 is enlarged in FIG. 26.

In the second embodiment, the block 80 includes a foundation portion (a first member) 81 and a lid portion (a second member) 82. In the block 80, a V-shaped groove 81a is provided in the foundation portion 81 instead of the through-hole 88. Otherwise, the configuration of the second embodiment is similar to the configuration of the first embodiment.

The groove 81a is formed according to the configuration of the optical fiber 2 and extends from the first surface F1 of the block 80 to the second surface F2. The portion 2f of the optical fiber 2 protruding from the ferrule 3 is disposed along the groove 81a from the first surface F1 side. Thereby, the foundation portion 81 houses one end of the optical fiber 2 inside the groove 81a and supports the one end of the optical fiber 2.

As illustrated in FIG. 26, a surface FV of the groove 81a includes a first groove surface FV1 and a second groove surface FV2. The first groove surface FV1 and the second groove surface FV2 each extend in a direction (the direction X1) along the central axis C1 of the optical fiber 2. The V-shaped configuration refers to a configuration in which the distance between the first groove surface FV1 and the second groove surface FV2 in a direction perpendicular to the direction X1 becomes narrower as the groove becomes deeper. For example, the V-shaped configuration may include cases where a connection portion CP between the first groove surface FV1 and the second groove surface FV2 has a curved configuration or a planar configuration.

A lid portion 82 is disposed to oppose the foundation portion 81. In other words, the lid portion 82 is provided on the foundation portion 81 and seals the groove 81a of the foundation portion 81. The lid portion 82 covers the one end of the optical fiber 2 housed inside the groove 81a from above. Thus, the one end of the optical fiber is clamped between the lid portion 82 and the groove 81a of the foundation portion 81.

The elastic member 83a is provided between the foundation portion 81 and the lid portion 82. The elastic member 83a is filled into the groove 81a. The elastic member 83a is disposed between the optical fiber 2 and the surface FV of the groove 81a and between the optical fiber 2 and the lid portion 82. Thereby, the elastic member 83a fixedly bonds the one end of the optical fiber 2 in the groove 81a and fixedly bonds the lid portion 82 to the foundation portion 81.

By such a configuration, the bonding strength can be increased because a sufficient amount of the bonding agent can be provided on the optical fiber 2 disposed on the groove 81a and between the groove 81a and the optical fiber 2. Also, the optical fiber 2 can be pressed onto the groove 81a by the lid portion 82; therefore, the optical fiber 2 can conform to the groove 81a with high precision.

By setting the lid portion 82 to be thin, the optical fiber 2 can be disposed proximally to the end of the block 80. However, in the case where the lid portion 82 is too thin, there are cases where the lid portion 82 undesirably breaks when pressing the optical fiber 2 to the groove 81a with the lid portion 82. Therefore, there are cases where it is difficult to dispose the optical fiber 2 proximal to the end of the block 80. In such a case, as in the first embodiment, the through-hole 88 is provided; and the optical fiber 2 is fixed in the through-hole 88. In the case where the through-hole 88 is used, the optical fiber 2 is not pressed; therefore, the optical fiber 2 can be disposed proximally to the end of the block 80. Also, the lid portion 82 may be set to be thick; and a groove similar to the groove 81a may be formed in the lid portion 82.

### Third Embodiment

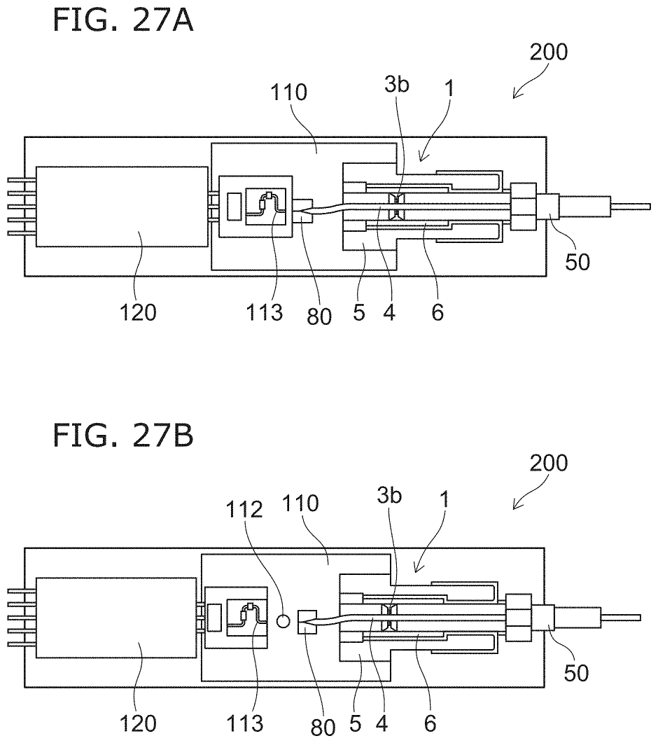

FIG. 27A and FIG. 27B are schematic views illustrating an optical transceiver according to a third embodiment.

As illustrated in FIG. 27A, the optical transceiver 200 according to the embodiment includes the optical receptacle 1, the optical element 110, and a control board 120.

A circuit and the like are formed on the control board 120. The control board 120 is electrically connected to the optical element 110. The control board 120 controls the operation of the optical element 110.

The optical element 110 includes, for example, a light-receiving element or a light-emitting element. In the example, the optical element 110 is a light emitter. The optical element 110 includes a laser diode 111. The laser diode 111 is controlled by the control board 120; and the light is emitted toward the fiber stub 4 of the optical receptacle 1.

As illustrated in FIG. 27A, the optical element 110 includes an element 113. The element 113 includes a laser diode and an optical waveguide having a small core diameter. The light that propagates through the core of the waveguide is incident on the optical receptacle 1. For example, the optical waveguide is formed using silicon photonics. Also, the optical waveguide may include a quartz waveguide. In the embodiment, the light that is emitted from the laser diode or the optical waveguide may be incident on the optical receptacle 1 via a lens 112 or the like as illustrated in FIG. 27B.

A plug ferrule 50 is inserted into the optical receptacle 1. The plug ferrule 50 is held by the sleeve 6. The optical fiber 2 is connected optically to the plug ferrule 50 at the end surface 3b. Thereby, the optical element 110 and the plug ferrule 50 are connected optically via the optical receptacle; and optical communication is possible.

The embodiment includes the following embodiments.

### Note 1

An optical receptacle, comprising:

a fiber stub including
an optical fiber including a core and cladding, the core being for transmitting light, and
a ferrule provided on one end side of the optical fiber;

a block separated from the ferrule, the block having one end surface, an other end surface on a side opposite to the one end surface, and a through-hole extending from the one end surface to the other end surface, a portion of the optical fiber protruding from the ferrule and being inserted into the through-hole from the one end surface side; and

a first elastic member fixing the optical fiber in the through-hole,

the portion of the optical fiber protruding from the ferrule including a first portion, a second portion, and a third portion,

the first portion being provided on the other end surface side of the third portion,

the second portion being provided between the first portion and the third portion,

a core diameter at the first portion being smaller than a core diameter at the third portion,

a core diameter at the second portion increasing from the first portion toward the third portion,

the first elastic member being provided between the optical fiber and an inner wall of the through-hole.

### Note 2

An optical receptacle, comprising:

a fiber stub including
an optical fiber including a core and cladding, the core being for transmitting light, and
a ferrule provided on one end side of the optical fiber;

a block separated from the ferrule, the block having one end surface, an other end surface on a side opposite to the one end surface, and a groove extending from the one end surface to the other end surface and having a V-shaped configuration, a portion of the optical fiber protruding from the ferrule and being disposed along the groove from the one end surface side; and

a first elastic member fixing the optical fiber in the groove,

the portion of the optical fiber protruding from the ferrule including a first portion, a second portion, and a third portion,

the first portion being provided on the other end surface side of the third portion,

the second portion being provided between the first portion and the third portion,

a core diameter at the first portion being smaller than a core diameter at the third portion,

a core diameter at the second portion increasing from the first portion toward the third portion,

the first elastic member being disposed between the optical fiber and the groove.

### Note 3

The optical receptacle according to Note 2, wherein

the block includes a first member where the groove is provided, and a second member opposing the first member,

the optical fiber is provided between the second member and the groove, and

the first elastic member is provided between the optical fiber and the groove and between the optical fiber and the second member.

### Note 4

The optical receptacle according to any one of Notes 1 to 3, wherein

an entirety of the first portion and an entirety of the second portion are positioned between the one end surface and the other end surface in a direction along a central axis of the optical fiber, and

the third portion includes a portion protruding from the one end surface.

### Note 5

The optical receptacle according to any one of Notes 1 to 3, wherein

at least a portion of the first portion is positioned between the one end surface and the other end surface in a direction along a central axis of the optical fiber, and

the second portion and the third portion protrude from the one end surface.

### Note 6

The optical receptacle according to any one of Notes 1 to 5, wherein

a refractive index of the core at the first portion, a refractive index of the core at the second portion, and a refractive index of the core at the third portion are equal to each other,

a refractive index of the cladding at the first portion is smaller than a refractive index of the cladding at the third portion, and

a refractive index of the cladding at the second portion increases from the first portion side toward the third portion side.

### Note 7

The optical receptacle according to any one of Notes 1 to 5, wherein

a refractive index of the cladding at the first portion, a refractive index of the cladding at the second portion, and a refractive index of the cladding at the third portion are equal to each other,

a refractive index of the core at the first portion is larger than a refractive index of the core at the third portion, and

a refractive index of the core at the second portion decreases from the first portion side toward the third portion side.

### Note 8

The optical receptacle according to any one of Notes 1 to 7, wherein a core diameter at the second portion increases linearly from the first portion side toward the third portion side.

### Note 9

The optical receptacle according to any one of Notes 1 to 7, wherein a core diameter at the second portion increases nonlinearly from the first portion side toward the third portion side.

### Note 10

The optical receptacle according to any one of Notes 1 to 7, wherein the core at the second portion includes a level difference at a portion of a region where a core diameter at the second portion increases from the first portion side to the third portion side.

### Note 11

The optical receptacle according to any one of Notes 1 to 10, wherein a core diameter at the first portion is not less than 0.5 μm and not more than 8 μm.

### Note 12

The optical receptacle according to any one of Notes 1 to 11, wherein a difference between a refractive index of the core and a refractive index of the cladding at the first portion is larger than a difference between a refractive index of the core and a refractive index of the cladding at the third portion.

### Note 13

The optical receptacle according to any one of Notes 1 to 12, wherein a difference between a refractive index of the core and a refractive index of the cladding at the first portion is larger than a difference between a refractive index of the core and a refractive index of the cladding at the second portion.

### Note 14

The optical receptacle according to any one of Notes 1 to 13, wherein a core diameter at the third portion is not less than 8 μm and not more than 20 μm.

### Note 15

The optical receptacle according to any one of Notes 1 to 14, wherein a difference between a refractive index of the core and a refractive index of the cladding at the third portion is smaller than a difference between a refractive index of the core and a refractive index of the cladding at the second portion.

### Note 16

The optical receptacle according to any one of Notes 1 to 15, wherein a difference between a refractive index of the core and a refractive index of the cladding at the second portion decreases from the first portion side toward the third portion side.

### Note 17

The optical receptacle according to any one of Notes 1 to 16, wherein an outer diameter of the optical fiber at the first portion is equal to an outer diameter of the optical fiber at the third portion.

### Note 18

The optical receptacle according to any one of Notes 1 to 17, wherein an outer diameter of the optical fiber at the second portion is smaller than an outer diameter of the optical fiber at the first portion.

### Note 19

The optical receptacle according to any one of Notes 1 to 18, wherein an outer diameter of the optical fiber at the second portion is smaller than an outer diameter of the optical fiber at the third portion.

### Note 20

The optical receptacle according to any one of Notes 1 to 17, wherein an outer diameter of the optical fiber at the second portion is larger than an outer diameter of the optical fiber at the first portion.

### Note 21

The optical receptacle according to any one of Notes 1 to 17, wherein an outer diameter of the optical fiber at the second portion is larger than an outer diameter of the optical fiber at the third portion.

### Note 22

The optical receptacle according to any one of Notes 1 to 21, wherein an end surface of the optical fiber on the block side is tilted from a plane perpendicular to a central axis of the optical fiber.

### Note 23

The optical receptacle according to any one of Notes 1 to 22, wherein the first portion, the second portion, and the third portion are made of one body.

### Note 24

The optical receptacle according to any one of Notes 1 to 23, wherein a length of the first portion along a central axis of the optical fiber is 5 μm or more.

### Note 25

The optical receptacle according to any one of Notes 1 to 24, wherein a length of the third portion along a central axis of the optical fiber is 5 μm or more.

### Note 26

The optical receptacle according to any one of Notes 1 to 25, wherein the block includes a transparent material.

### Note 27

The optical receptacle according to any one of Notes 1 to 25, wherein the block includes a ceramic.

### Note 28

The optical receptacle according to any one of Notes 1 to 25, wherein the block includes a resin.

### Note 29

The optical receptacle according to any one of Notes 1 to 28, wherein a transparent member is disposed at an end surface of the optical fiber on the other end surface side of the block.

### Note 30

The optical receptacle according to any one of Notes 1 to 29, further comprising:

a cover portion covering at least a portion of a portion of the optical fiber protruding from the one end surface of the block; and

a second elastic member provided between the cover portion and the block.

### Note 31

The optical receptacle according to Note 30, further comprising a third elastic member provided between the cover portion and the block,

the third elastic member being positioned between the block and the second elastic member.

### Note 32

The optical receptacle according to any one of Notes 1 to 31, wherein the block includes a level-difference portion arranged with a portion of the optical fiber protruding from the one end surface in a direction perpendicular to a central axis of the optical fiber.

### Note 33

The optical receptacle according to Note 32, wherein at least a portion of an end portion of the level-difference portion is beveled.

### Note 34

The optical receptacle according to Note 1, further comprising a cover portion,

the through-hole including an increasing-diameter portion provided on the one end surface side,

a diameter of the increasing-diameter portion increasing in a direction along a central axis of the optical fiber,

the cover portion covering a portion of the optical fiber disposed inside the increasing-diameter portion.

### Note 35

The optical receptacle according to Note 1, wherein the first elastic member includes a portion provided inside the through-hole, and a portion jutting from the through-hole.

### Note 36

An optical transceiver, comprising the optical receptacle according to any one of Notes 1 to 35.

According to the optical receptacle of Note 1, the core diameter at the first portion is smaller than the core diameter at the third portion; therefore, the loss at the optical connection surface can be suppressed; and the length of the optical module can be shortened.

By forming the second portion, the optical loss at the second portion can be suppressed because an abrupt change of the core shape can be suppressed when transitioning from the first portion to the third portion.

Further, the loss of the light at the first portion and the third portion is small; therefore, in the case where the second portion is provided inside the through-hole of the block, the second portion may be positioned anywhere inside the through-hole. Thereby, precise length control of the optical fiber is unnecessary; and the optical receptacle can be manufactured economically.

Also, by causing the MFD of the optical element such as an optical integrated circuit or the like and the MFD of the block interior to approach each other, a connection method (a butt-joint) is possible in which the block is directly pressed onto the optical element while suppressing the coupling loss due to the MFD difference; and the optical devices between the optical element and the block can be reduced. Thereby, a cost reduction and a decrease of the loss due to the device alignment error are possible. Also, by fixing the optical fiber in the through-hole, the number of component parts of the block can be low (e.g., 1); and the number of manufacturing processes can be reduced because the assembly can be performed by inserting the optical fiber into the block.

Further, the configurations of the first portion and the third portion do not change with respect to the axis direction; and the loss of the light is small; therefore, in the case where the second portion is provided in the through-hole of the block, the second portion can be located without problems anywhere inside the through-hole. Thereby, precise length control of the optical fiber on the fiber block is unnecessary; and the receptacle can be manufactured economically.

According to the optical receptacle of Note 2, the length of the optical module can be small because the core diameter at the first portion is smaller than the core diameter at the third portion.

Also, by forming the second portion, the optical loss at the second portion can be suppressed because an abrupt change of the core shape can be suppressed when transitioning from the first portion to the third portion.

Further, the configurations of the first portion and the third portion do not change with respect to the axis direction; and the loss of the light is small; therefore, in the case where the second portion is provided on the groove of the block, the second portion can be located without problems anywhere on the groove. Thereby, precise length control of the optical fiber is unnecessary; and the receptacle can be manufactured economically.

Also, in the case where a bonding agent is used as the first elastic member, the bonding strength can be increased because a sufficient amount of the bonding agent can be provided between the groove and the optical fiber and at the upper portion of the optical fiber disposed on the groove.

According to the optical receptacle of Note 3, the optical fiber can be pressed onto the groove by the second member. Thereby, the optical fiber can conform to the groove with high precision.

According to the optical receptacle of Note 4, the second portion can be protected from stress from the outside by using the first elastic member to fix the entire regions of the first portion and the second portion to conform to the block.

According to the optical receptacle of Note 5, even if the diameter of the cladding at the second portion changes when fusing the optical fiber, only the first portion conforms to the through-hole or the V-shaped groove of the block. For example, the diameter of the first portion is the same over the entire region of the first portion. Therefore, the optical fiber can be fixed to the block without affecting the positional relationship between the block and the core.

According to the optical receptacle of Note 6, by using a fiber having a large refractive index difference, the light can be confined without scattering even for a small core diameter; and the loss when the light is incident on the fiber can be suppressed. Also, by forming the second portion, the optical loss at the second portion can be suppressed because an abrupt change of the refractive index difference can be suppressed when transitioning from the first portion to the third portion. Also, the raw material of the core can be used commonly; and the loss due to the reflections at the connection portions can be suppressed because a refractive index difference between the cores does not exist at the connection portion between the first portion and the second portion and the connection portion between the second portion and the third portion.

According to the optical receptacle of Note 7, the cladding can have uniform properties because the cladding can be formed of the same raw material. Thereby, because the melting point also is uniform, the forming of the cladding outer diameter when fusing can be performed easily.

According to the optical receptacle of Note 8, even if a laser entering the second portion spreads in a radial configuration, the laser is incident at a small angle at the boundary between the cladding and the core; and the light can be prevented from escaping to the cladding side by total internal reflection of the light.

According to the optical receptacle of Note 9, the manufacturing can be relatively easily because it is unnecessary for the fused fiber tensile speed, the fusion discharge time, and the power to be controlled with high precision when forming the second portion.

According to the optical receptacle of Note 10, the manufacturing can be performed relatively easily because it is unnecessary for the fused fiber tensile speed, the fusion discharge time, and the power to be controlled with high precision when forming the second portion. Also, by using this configuration, the choices of the fibers used in the fusing can be greater because even fibers that have different melting points can be connected.

According to the optical receptacle of Note 11, by setting the MFD of the fiber side to be small for the light emitted from a fine optical waveguide, it is no longer necessary to provide a zoom for the light when the light is incident on the fiber. Thereby, a shortening of the coupling distance is realized; and this also can contribute to simplifying the lens.

According to the optical receptacle of Note 12, in the case where light having a beam waist smaller than the third portion propagates through the first portion, the light can propagate with a single mode and with low loss.

According to the optical receptacle of Note 13, in the case where light having a beam waist smaller than the second portion propagates through the first portion, the light can propagate with a single mode and with low loss.

According to the optical receptacle of Note 14, the MFD can be matched to an optical communication single-mode fiber generally used currently; therefore, the coupling loss caused by the MFD difference when coupling to the plug ferrule can be suppressed.

According to the optical receptacle of Note 15, in the case where light having a beam waist larger than the second portion propagates through the third portion, the light can propagate with a single mode and with low loss.

According to the optical receptacle of Note 16, the refractive index decreases gradually toward the third portion side from the first portion side; therefore, an abrupt refractive index change between the first portion and the third portion can be prevented; and the optical loss due to reflections and/or scattering at the coupling position between the first portion and the third portion can be suppressed.

According to the optical receptacle of Note 17, by setting the exterior forms of the first portion and the third portion to be equal, the central axis misalignment between the first portion and the third portion can be prevented; and the fusion loss caused by axial misalignment can be suppressed.

According to the optical receptacle of Note 18, the elastic member exists in a wedge-like configuration at the outer perimeter of the second portion where the outer diameter of the optical fiber becomes finer; therefore, a protrusion of the optical fiber outside the ferrule is suppressed; and chipping and/or cracks of the outer perimeter of the optical fiber can be suppressed.

According to the optical receptacle of Note 19, by providing the cladding outer diameter difference between the second portion and the third portion, the wedge effect due to the elastic member filled outside the cladding of the second portion can be more effective.

According to the optical receptacle of Note 20, the strength of the fused portion can be increased by setting the outer diameter of the optical fiber at the second portion to be large.

According to the optical receptacle of Note 21, the strength of the fused portion can be increased by setting the outer diameter of the optical fiber at the second portion to be large.

According to the optical receptacle of Note 22, the end surface of the optical fiber is tilted from the plane perpendicular to the central axis of the optical fiber; therefore, the light that is emitted from the optical element connected to the optical receptacle is incident on the optical fiber, is reflected by the end surface of the optical fiber, and is prevented from returning to the optical element; and the optical element can be operated stably.

According to the optical receptacle of Note 23, by forming the optical fiber as one body, optical loss can be suppressed by preventing the occurrence of a gap at each boundary between the first portion, the second portion, and the third portion.

According to the optical receptacle of Note 24, the optical loss caused by fluctuation of the polishing and the length of the optical fiber can be suppressed.

According to the optical receptacle of Note 25, the optical loss caused by fluctuation of the polishing and the length of the optical fiber can be suppressed.

According to the optical receptacle of Note 26, because ultraviolet can pass through the block, UV curing can be performed at the bottom surface of the block when fixing the block to a transceiver or the like.

According to the optical receptacle of Note 27, by using a ceramic as the block, the block can have various functions. For example, in the case where a low thermal expansion ceramic is used, the misalignment of the position of the block with respect to the optical element such as an optical integrated circuit, etc., due to the temperature after bonding the block can be suppressed.

According to the optical receptacle of Note 28, the production cost can be suppressed to be low by manufacturing the block using a high-precision mold with a resin as the material.

According to the optical receptacle of Note 29, by mounting an isolator as the transparent member, the reflection of the light incident on the first portion from the optical element or the light emitted from the first portion toward the optical element can be suppressed.

According to the optical receptacle of Note 30, breakage of the optical fiber can be suppressed by providing the second elastic member at the portion of the optical fiber protruding from the block. Also, breakage of the cover portion can be suppressed by providing the second elastic member between the block and the cover portion covering the optical fiber.

According to the optical receptacle of Note 31, breakage of the optical fiber can be suppressed by providing the third elastic member at the portion of the optical fiber protruding from the block. Also, breakage of the cover portion can be suppressed by providing the third elastic member between the block and the cover portion covering the optical fiber.

According to the optical receptacle of Note 32, by including the level-difference portion arranged with the optical fiber, the coated surface area of the bonding agent can be wider; and the concentration of bending stress at the interface between the optical fiber and the block can be prevented.

According to the optical receptacle of Note 33, in the case where the optical fiber and/or the cover portion contacts the level-difference portion, the contact portion can be suppressed from becoming a starting point of breakage of the optical fiber and/or breakage of the cover portion.

According to the optical receptacle of Note 34, by using the elastic member to fix the cover portion inside the increasing-diameter portion, the bonding strength and the reinforcing strength of the optical fiber are increased; and breakage of the optical fiber is prevented.

According to the optical receptacle of Note 35, because the first elastic member includes a portion jutting from the through-hole, breakage of the optical fiber at the portion of the optical fiber protruding from the block can be suppressed.

According to the optical transceiver of Note 36, by reducing the core of the optical fiber on the optical element-side-end surface and by fusing a fiber having a larger refractive index difference between the core and the cladding than that of a fiber generally used in a transmission line, the loss at the optical connection surface can be suppressed; and by forming a portion where the refractive index and the core diameter transition gradually at the fused portion between the fiber generally used in a transmission line and the fiber having the large refractive index difference between the core and the cladding, the conversion efficiency of the mode field can be suppressed while contributing to the shortening of the optical total module length; as a result, the decrease of the coupling efficiency from the optical element to the plug ferrule can be suppressed.

The embodiments of the invention have been described above. However, the invention is not limited to the above description. Those skilled in the art can appropriately modify the above embodiments, and such modifications are also encompassed within the scope of the invention as long as they include the features of the invention. For instance, the shape, dimension, material, arrangement and the like of various components in the optical receptacle are not limited to those illustrated, but can be modified appropriately.

Furthermore, various components in the above embodiments can be combined with each other as long as technically feasible. Such combinations are also encompassed within the scope of the invention as long as they include the features of the invention.

What is claimed is:

1. An optical receptacle, comprising:
a fiber stub including
an optical fiber including a core and cladding, the core being for transmitting light, and
a ferrule provided on one end side of the optical fiber;
a block separated from the ferrule, the block having one end surface, an other end surface on a side opposite to the one end surface, and a through-hole extending from the one end surface to the other end surface, a portion of the optical fiber protruding from the ferrule and being inserted into the through-hole from the one end surface side; and
a first elastic member fixing the optical fiber in the through-hole,
the portion of the optical fiber protruding from the ferrule including a first portion, a second portion, and a third portion,
the first portion being provided on the other end surface side of the third portion,
the second portion being provided between the first portion and the third portion,
a core diameter at the first portion being smaller than a core diameter at the third portion,
a core diameter at the second portion increasing from the first portion toward the third portion,
the first elastic member being provided between the optical fiber and an inner wall of the through-hole.

2. An optical receptacle, comprising:
a fiber stub including
an optical fiber including a core and cladding, the core being for transmitting light, and
a ferrule provided on one end side of the optical fiber;
a block separated from the ferrule, the block having one end surface, an other end surface on a side opposite to the one end surface, and a groove extending from the one end surface to the other end surface and having a V-shaped configuration, a portion of the optical fiber protruding from the ferrule and being disposed along the groove from the one end surface side; and
a first elastic member fixing the optical fiber in the groove,
the portion of the optical fiber protruding from the ferrule including a first portion, a second portion, and a third portion,
the first portion being provided on the other end surface side of the third portion,
the second portion being provided between the first portion and the third portion,
a core diameter at the first portion being smaller than a core diameter at the third portion,
a core diameter at the second portion increasing from the first portion toward the third portion,
the first elastic member being disposed between the optical fiber and the groove.

3. The receptacle according to claim 2, wherein
the block includes a first member where the groove is provided, and a second member opposing the first member,
the optical fiber is provided between the second member and the groove, and
the first elastic member is provided between the optical fiber and the groove and between the optical fiber and the second member.

4. The receptacle according to claim 1, wherein
an entirety of the first portion and an entirety of the second portion are positioned between the one end surface and the other end surface in a direction along a central axis of the optical fiber, and
the third portion includes a portion protruding from the one end surface.

5. The receptacle according to claim 1, wherein
at least a portion of the first portion is positioned between the one end surface and the other end surface in a direction along a central axis of the optical fiber, and
the second portion and the third portion protrude from the one end surface.

6. The receptacle according to claim 1, wherein
a refractive index of the core at the first portion, a refractive index of the core at the second portion, and a refractive index of the core at the third portion are equal to each other,
a refractive index of the cladding at the first portion is smaller than a refractive index of the cladding at the third portion, and
a refractive index of the cladding at the second portion increases from the first portion side toward the third portion side.

7. The receptacle according to claim 1, wherein
a refractive index of the cladding at the first portion, a refractive index of the cladding at the second portion, and a refractive index of the cladding at the third portion are equal to each other,
a refractive index of the core at the first portion is larger than a refractive index of the core at the third portion, and
a refractive index of the core at the second portion decreases from the first portion side toward the third portion side.

8. The receptacle according to claim 1, wherein an end surface of the optical fiber on the block side is tilted from a plane perpendicular to a central axis of the optical fiber.

9. The receptacle according to claim 1, wherein a transparent member is disposed at an end surface of the optical fiber on the other end surface side of the block.

10. The receptacle according to claim 1, further comprising:
a cover portion covering at least a portion of a part of the optical fiber protruding from the one end surface of the block; and
a second elastic member provided between the cover portion and the block.

11. The receptacle according to claim 10, further comprising a third elastic member provided between the cover portion and the block,
the third elastic member being positioned between the block and the second elastic member.

12. An optical transceiver including an optical receptacle,
the optical receptacle including:
a fiber stub including
an optical fiber including a core and cladding, the core being for transmitting light, and
a ferrule provided on one end side of the optical fiber;
a block separated from the ferrule, the block having one end surface, an other end surface on a side opposite to the one end surface, and a through-hole extending from the one end surface to the other end surface, a portion of the optical fiber protruding from the ferrule and being inserted into the through-hole from the one end surface side; and
a first elastic member fixing the optical fiber in the through-hole,
the portion of the optical fiber protruding from the ferrule including a first portion, a second portion, and a third portion,
the first portion being provided on the other end surface side of the third portion,
the second portion being provided between the first portion and the third portion,
a core diameter at the first portion being smaller than a core diameter at the third portion,
a core diameter at the second portion increasing from the first portion toward the third portion,
the first elastic member being provided between the optical fiber and an inner wall of the through-hole.
